(19) United States
(12) Patent Application Publication
(10) Pub. No.: US 2026/0134624 A1
(43) Pub. Date: May 14, 2026

(54) CONDITIONAL HUMAN MESH RECOVERY IN MULTI-PERSON SCENES

(71) Applicant: NAVER CORPORATION, Gyeonggi-do (KR)

(72) Inventors: Romain BRÉGIER, Bougnon (FR); Fabien Baradel, Meylan (FR); Thomas Lucas, Grenoble (FR); Matthieu Armando, Saint-Jorioz (FR); Phillippe Weinzaepfel, Montbonnot-Saint-Martin (FR); Grégory Rogez, Gières (FR)

(73) Assignee: NAVER CORPORATION, Gyeonggi-do (KR)

(21) Appl. No.: 18/944,362

(22) Filed: Nov. 12, 2024

(51) Int. Cl. G06T 17/20; G06T 7/55; G06T 7/73; G06T 15/06; G06V 10/77; G06V 10/82; G06V 20/64; G06V 40/16

(52) U.S. Cl. CPC G06T 17/20; G06T 7/55; G06T 7/74; G06T 15/06; G06T 2207/20076; G06T 2207/20081; G06T 2207/20084; G06T 2207/30196; G06T 2210/56; G06V 10/7715; G06V 10/82; G06V 20/64; G06V 40/174

(57) ABSTRACT

A computer-implemented method for recovering a three-dimensional (3D) mesh of N humans in a 3D scene, includes: receiving a two-dimensional (2D) image of the scene captured by an image capturing device, the 2D image including a plurality of regions; by one or more processors, encoding the received image and extracting features for each of the plurality of regions; by one or more processors, detecting the N humans in N respective regions among the plurality of regions; by one or more processors, based on the features in the N respective regions and the features for each of the plurality of regions, determining distribution parameters for distributions of body model and depth parameters for each of the N detected humans using a probabilistic network; providing the distribution parameters for the body model parameters for each of the N detected humans to a 3D parametric model for generating N 3D meshes.

### FIELD

The present disclosure relates to machine learning and more particularly to systems and methods for human mesh recovery (HMR) in environments including two or more humans.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

For various applications it is useful to provide whole-body mesh recovery from a single image. Whole-body parametric models may be used for mesh recovery. For example, SMPL-X (Pavlakos et al., Expressive body capture: 3d hands, face, and body from a single image, In CVPR, 2019, which is incorporated herein in its entirety) can output an expressive mesh for the whole body given a small set of pose and shape parameters. However, it remains difficult to efficiently and accurately provide such parameters of a person in an image, e.g., in real-time. For example, approaches based on optimization, such as SMPL-X remain slow and sensitive to local minima.

Other learning-based methods may be used, but only in single-person settings. Further, such methods pose significant challenges. For example, hands and faces are typically low resolution in natural images, and capturing their poses hinges on subtle details.

In various implementations, a multi-crop pipeline may be leveraged, in which areas of interest such as the face and hands are cropped, resized, and used to estimate the associated meshes. The meshes are then aggregated into a whole-body prediction. For example, ExPose (Choutas et al., Monocular expressive body regression through body-driven attention. In ECCV, 2020, which is incorporated herein in its entirety) selects high-resolution crops using a body-driven attention mechanism. PIXIE (Feng et al., Collaborative regression of expressive bodies using moderation, In 3DV, 2021, which is incorporated herein in its entirety) fuses body parts in an adaptive manner. Hand4Whole (Moon et al., Accurate 3d hand pose estimation for whole-body 3d human mesh estimation, In CVPR Workshop, 2022, which is incorporated herein in its entirety) uses both body and hand joint features for robust 3D wrist rotation estimation.

### SUMMARY

In a feature, a computer-implemented method for recovering a three-dimensional (3D) mesh of N humans in a 3D scene, where N is an integer greater than or equal to zero, is described and includes: receiving a two-dimensional (2D) image of the scene captured by an image capturing device, the 2D image including a plurality of regions; by one or more processors, encoding the received image and extracting features for each of the plurality of regions; by one or more processors, detecting the N humans in N respective regions among the plurality of regions; by one or more processors, based on the features in the N respective regions and the features for each of the plurality of regions, determining distribution parameters for distributions of body model and depth parameters for each of the N detected humans using a probabilistic network; providing the distribution parameters for the body model parameters for each of the N detected humans to a 3D parametric model for generating N 3D meshes based on the distribution parameters; and placing each of the N generated meshes at a respective 3D spatial location in the 3D scene based on the distribution parameters for the depth parameters.

In further features, the body model parameters include pose and shape parameters, and the 3D mesh is a whole-body mesh.

In further features, the probabilistic network includes a Bayesian network.

In further features, the body model and depth parameters include location, body shape, pose, facial expression, depth, and intrinsic parameters of the image capturing device.

In further features, the determining the distribution parameters for distributions of body model and depth parameters body model and depth parameters includes determining a distribution for the location based on the intrinsic parameters and the body shape.

In further features, the determining the distribution parameters for distributions of body model and depth parameters body model and depth parameters includes determining a distribution for the body shape based on the features.

In further features, the determining the distribution parameters for distributions of body model and depth parameters body model and depth parameters includes determining a distribution for the pose based on the features and the distribution for the body shape.

In further features, the determining the distribution parameters for distributions of body model and depth parameters body model and depth parameters includes determining a distribution for the facial expression based on the features and the distributions for the pose and the body shape.

In further features, the determining the distribution parameters for distributions of body model and depth parameters body model and depth parameters includes determining the intrinsic parameters based on a CLS token of the 2D image.

In further features, the determining the distribution parameters for distributions of body model and depth parameters body model and depth parameters includes determining a distribution for the depth based on the features and the distribution for the body shape.

In further features, the determining the distribution parameters for distributions of body model and depth parameters body model and depth parameters includes determining a distribution for the location based on the distribution for depth and the intrinsic parameters.

In further features, the determining the distribution parameters for distributions of body model and depth parameters body model and depth parameters includes determining a distribution for the facial expression based on the features and the distributions for the body shape and the depth.

In further features, the determining the distribution parameters for distributions of body model and depth parameters body model and depth parameters includes determining a distribution for the depth based on the features.

In further features, the determining the distribution parameters for distributions of body model and depth parameters body model and depth parameters includes determining a distribution for the body shape based on the features and the distribution for the depth.

In further features, the determining the distribution parameters for distributions of body model and depth parameters body model and depth parameters includes determining a distribution for the pose based on the features and the distributions for the depth and the body shape.

In further features, the determining the distribution parameters for distributions of body model and depth parameters body model and depth parameters includes determining a distribution for the facial expression based on the features and the distributions for the body shape and the pose.

In further features, determining the distribution parameters for distributions of body model and depth parameters body model and depth parameters includes determining the distribution parameters for the distributions of the body model and depth parameters further based on embedded values of ray directions of the image capture device.

In further features, the detecting N humans includes detecting a predetermined body keypoint in each of the N respective regions, and where a portion of each generated 3D mesh is centered around the predetermined body keypoint.

In further features, the predetermined body keypoint includes one of a human head, torso, midsection, spine, or pelvis.

In further features, detecting a predetermined keypoint includes: generating, for each of the plurality of regions, a probability that the predetermined body keypoint is present within the region; and determining whether the predetermined body keypoint is present within a region based on a comparison of the generated probability for the region with a threshold.

In further features, the determining whether the predetermined body keypoint is present within a region includes determining that the predetermined body keypoint is present within the region when the generated probability for the region is greater a threshold value.

In further features, the encoding the received image includes encoding the received image using a Vision Transformer.

In further features, the probabilistic network is trained using a dataset including synthetic generated images.

In further features, the method further includes performing a downstream task using the generated 3D meshes.

In further features, the downstream task includes at least one of: generating a virtual 3D avatar; moving a virtual 3D avatar; actuating an autonomous device; and controlling an interaction between a between a human and an autonomous device.

In further features, the downstream task includes controlling movement of an autonomous device to avoid objects based on the generated 3D meshes.

In further features, the distribution parameters include probability densities.

In further features, the determining the distribution parameters for distributions of body model and depth parameters body model and depth parameters includes determining the distribution parameters based on a predetermined body shape.

In further features, the determining the distribution parameters for distributions of body model and depth parameters body model and depth parameters includes determining the distribution parameters based on predetermined intrinsic parameters of the image capture device.

In further features, the determining the distribution parameters for distributions of body model and depth parameters body model and depth parameters includes determining the distribution parameters for the body model and depth parameters based on: based on the features; and features of M other images taken at approximately the same time as the received image from different points of view than a point of view of the received image.

In a feature, a computer-implemented architecture for recovering a three-dimensional (3D) mesh of N humans in a 3D scene, where N is an integer greater than or equal to zero, is described and the architecture includes: an image encoder module configured to receive a two-dimensional (2D) image of the scene including a plurality of regions from an image capturing device and encode the received image and extract features for each of the plurality of regions; a detector module configured to detect the N humans in N respective regions among the plurality of regions; a decoder module configured to, based on the features in the N respective regions and the features for each of the plurality of regions, determining distribution parameters for distributions of body model and depth parameters for each of the N detected humans using a probabilistic network; a 3D parametric model configured to receive the distribution parameters for the body model and depth parameters for each of N detected humans and generate N 3D meshes based on ones of the distribution parameters; and a mesh positioning module configured to place each of the N generated 3D meshes at a respective 3D spatial location in the 3D scene based on ones of the distribution parameters.

In a feature, a computer-implemented method for recovering a three-dimensional (3D) mesh of N humans in a 3D scene, where N is an integer greater than or equal to zero, is described and includes: receiving a two-dimensional (2D) image of the scene captured by an image capturing device, the 2D image including a plurality of regions; by one or more processors, encoding the received image and extracting features for each of the plurality of regions; by one or more processors, detecting the N humans in N respective regions among the plurality of regions; by one or more processors, based on the features in the N respective regions and the features for each of the plurality of regions, defining a feature vector for each of the N detected humans using a probabilistic network; by one or more processors, determining conditional probability distribution parameters for a plurality of human attributes based on each feature vector, including shape, pose and depth, where determining the conditional probability distribution parameters includes determining at least one of shape, pose, and depth based on at least one other one of the shape, pose, and depth; by one or more processors, providing the distribution parameters for the body model parameters for each of the N detected humans to a 3D parametric model for generating N 3D meshes based on the distribution parameters; and by one or more processors, placing each of the N generated meshes at a respective 3D spatial location in the 3D scene based on the distribution parameters for the depth parameters.

In a feature, a computer-implemented architecture for recovering a three-dimensional (3D) mesh of N humans in a 3D scene, where N is an integer greater than or equal to zero, is described and the architecture includes: one or more processors; and memory including code that, when executed by the one or more processors, perform to: receive a two-dimensional (2D) image of the scene including a plurality of regions from an image capturing device; encode the received image and extract features for each of the plurality of regions; detect the N humans in N respective regions among the plurality of regions; based on the features in the N respective regions and the features for each of the plurality of regions, determine distribution parameters for distributions of body model and depth parameters for each of the N detected humans using a probabilistic network; using a 3D parametric model, generate N 3D meshes for the N detected humans based on ones of the distribution parameters; and place each of the N generated 3D meshes at a respective 3D spatial location in the 3D scene based on ones of the distribution parameters.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 shows an example 3D recovery architecture;

FIG. 2 shows an example 3D mesh recovery method;

FIG. 3 illustrates operation of an example Multi-HMR architecture for performing a 3D mesh recovery method;

FIG. 4A shows features of an example prediction head for a 3D recovery architecture;

FIG. 4B shows features of an example block in the prediction head of FIG. 4A;

FIG. 4C shows an example data flow for regressing parameters using the multilayered perceptrons (MLPs) in FIG. 4A;

FIG. 5 shows an example inference method;

FIG. 6 shows an example input 2D image (left), along with predicted 3D whole-body human 3D meshes and an example side-view of the seven generated 3D meshes (right);

FIG. 7 shows experimental comparisons of example 3D mesh recovery methods for multi-person body-only mesh recovery (top) and single-person whole-body mesh recovery (bottom);

FIG. 8, right, shows an example a performance comparison for distance estimation to the state of the art; and FIG. 8, left shows a comparison of methods where camera intrinsics were used to condition an example model;

FIGS. 9-11 show results of example ablation experiments using example 3D mesh recovery methods;

FIGS. 12-13 show example qualitative examples (visualizations) including the input image and example results from Multi-HMR overlaid on the image.

FIG. 12 shows images from EHF (top), MuPoTs (middle), and UBody (bottom).

FIG. 13 shows images from AGORA (top), 3DPW (middle), and CMU (bottom);

FIG. 14 shows examples of rendered avatars and their associated SMPL-X meshes;

FIG. 15 shows examples from a synthetic booster dataset showing the input image, the overlaid SMPL-X annotations, the close-up image, and annotations around the hands corresponding to the rectangle shown in the second column;

FIG. 16 illustrates increasing hand diversity in human shape sources to be rendered;

FIG. 17 shows results of experiments incorporating training with synthetic booster datasets;

FIGS. 18-20 show results of additional ablation experiments;

FIGS. 21-26 show randomly selected images provided from various test and validation datasets used in example experiments, including EHF (FIG. 21), MuPoTS (FIG. 22), AGORA (FIG. 23, CMU panoptics (FIG. 24), 3DPW (FIG. 25), and UBody (FIG. 26);

FIG. 27 shows results of experiments evaluating an impact of focal length;

FIG. 28 shows an example network and hardware architecture for performing example methods;

FIGS. 29A, 29B, and 30 include functional block diagrams of systems for multiple human mesh recovery using a probabilistic network;

FIG. 31 includes example renderings generated with and without using predetermined camera intrinsics and body shape;

FIGS. 32(a)-(j) includes images illustration human mesh recovery;

FIG. 33 includes an input image and FIG. 34 includes images illustration human mesh recovery based on the input image of FIG. 33;

FIGS. 35(a)-(d) illustrate example interrelationships between estimated body model and depth parameters;

FIG. 36 is a flowchart depicting an example method of determining human meshes using the probabilistic network based on a single input image; and

FIG. 37 is a flowchart depicting an example method of determining human meshes using the probabilistic network based on multiple input image.

In the drawings, reference numbers may be reused to identify similar and/or identical elements.

### DETAILED DESCRIPTION

Example methods and systems herein include or incorporate models for strong multi-person three-dimensional (3D) human mesh recovery (e.g., recovery of parameters describing a person in an image, the parameters may be used to generate a mesh of the person). Example 3D recovery models can be single-shot, in that they can perform recovery from a single image, e.g., a single two-dimensional (2D) RGB image taken from an image-capturing device, such as a camera (examples of which are generally referred to as “cameras” herein). Predictions generated from example 3D recovery models can include a whole-body, which may include but is not limited to expressions such as face and hand expressions. Example predictions provide inputs which can include or be processed to include parameters for a downstream parametric mesh recovery model, a nonlimiting example of which being a SMPL-X parametric model, as well as coordinates for a spatial location in a camera coordinate system (coordinate system of the camera). Example 3D mesh recovery methods herein can be faster to train than other methods, can achieve improved performance, and can be more efficient at inference.

Example methods and systems provide, among other things, a framework based on a neural network backbone configured to recover, e.g., predict, 3D meshes of humans. The 3D meshes may be, but need not be, whole-body. “Whole-body” may refer to a 3D mesh of a complete or near-complete human body (e.g., greater than 80%, 90%, 95%, 98%, or more of a complete 3D outer human body surface, or complete human body parts that have not been occluded from or are not outside the field of view of a scene recorded with an image capturing device). “Humans” or “people” may refer herein to providing a plurality of human or humanoid body surface meshes; i.e., multi-person detection.

Example methods and systems may include any combination of one or more of, up to and including all of, the following features:

Models may relatively efficiently detect a variable number of two or more people, including multiple humans, in a scene.

Models may recover whole-body 3D meshes.

Models may be single-shot, in that it recovers the 3D meshes from a single RGB image. “Single-shot” may refer to example models performing 3D recovery from a single image input, e.g., by directly regressing an expected output without extracting or resampling features from different crops.

Predicted 3D meshes may be expressive. “Expressive” may refer to 3D meshes that capture expressive body poses, such as but not limited to face and/or hand poses, where such poses are available.

Predicted 3D meshes may be positioned in a scene within a spatial location such as a camera space. “Camera space” may refer to a 3D space that is definable or defined by a camera coordinate system.

3D recovery may be camera aware. “Camera aware” may refer to the 3D recovery being adaptive or adaptable to camera information, when known.

Example 3D recovery models incorporating the above features are referred to herein as Multi-HMR (multiple human mesh recovery) models. An example Multi-HMR model is a real-time single-shot detector (model) configured to regress pose and shape parameters of a whole-body model for a variable number of humans as predicted 3D meshes and place the predicted 3D meshes in camera space, and may be conditioned on camera intrinsics when available.

By contrast, other methods such as disclosed in Kanazawa et al., End-to-end recovery of human shape and pose, In CVPR, 2018, which is incorporated herein in its entirety, may predict SMPL mesh parameters and three parameters for weak-perspective reprojection given a cropped image containing a person. Different aspects have been improved, including architectures, training techniques, and data enhancements. Such approaches have further been extended to whole-body parametric models such as SMPL-X, as disclosed in Pavlakos et al., 2019, which is incorporated herein in its entirety.

Multi-person mesh recovery methods may include a multi-stage framework, including operating an off-the-shelf human detector, followed by applying a single-person mesh recovery model on crops around each detected person. However, such approaches may have drawbacks. For example, they may be inefficient at inference time, compared to a single-shot approach. Further, a recovery pipeline may not be optimized end-to-end. These drawbacks impact overall performance, particularly in cases of truncation by the image frame, or with person-person occlusions, a common scenario in multi-person settings.

Systems such as ROMP (Sun et al., Monocular, one-stage, regression of multiple 3d people. In ICCV, 2021, which is incorporated herein in its entirety), BEV (Sun et al., Putting people in their place: Monocular regression of 3d people in depth, In CVPR, 2022, which is incorporated herein in its entirety), and PSVT (Qiu et al., Psvt: End-to-end multi-person 3d pose and shape estimation with progressive video transformers, In CVPR, 2023, which is incorporated herein in its entirety) recover multiple human meshes in a single step using one-shot detectors. ROMP, for example, estimates 2D maps for 2D human detections, positions, and mesh parameters. A single-stage model, BEV, introduces an additional Bird-Eye-View representation of a scene to predict a relative depth between detected persons. PSVT improves performance using a transformer decoder. However, such systems do not provide whole-body mesh recovery, nor do they consider camera intrinsics for improving accuracy, let alone in combination with regressing a 3D spatial location of each person, e.g., in a camera coordinate system.

Other techniques, such as SPEC and CLIFF, account for certain intrinsic camera parameters for improving reprojection (Kocabas et al., Spec: Seeing people in the wild with an estimated camera, in ICCV, 2021, which is incorporated herein in its entirety; Li et al., Cliff: Carrying location information in full frames into human pose and shape estimation, In ECCV, 2022, which is incorporated herein in its entirety) for single-person human detection, especially when these differ between training and inference. However, such techniques do not perform one-shot 3D recovery for multiple humans in a scene, nor do they provide whole-body mesh detection.

Other methods such as OSX (Lin et al., One-stage 3d whole-body mesh recovery with component aware transformer, In CVPR, 2023, which is incorporated herein in its entirety) may provide a single-crop method for single-person whole-body mesh recovery by leveraging a ViT encoder, followed by a high-resolution feature pyramid, and using keypoint (e.g., wrists) estimates to resample features in a decoder head. However, such methods do not provide multi-person whole-body mesh recovery, let alone by using a single-shot approach. In contrast to earlier approaches, example 3D recovery models herein can be single-shot without requiring high-resolution crops, and further need not require a hierarchical feature extractor.

An example one-stage 3D recovery model herein includes an image encoder, which can be based on, for example, a trainable neural backbone such as a standard vision (or visual) Transformer (ViT) backbone to extract embedded features in an image, e.g., as detected token features, where each token corresponds to a region in the image. A detector is provided that is configured to predict whether a person is present in regions of the image, such as by predicting a coarse 2D person center heatmap, which provides a probability of the presence or absence of a person centered at a given location for each input token.

A decoder, e.g., including a prediction head, is configured to predict for each detected person, body model parameters, such as but not limited to pose and shape parameters, for an expressive human parametric model, e.g., SMPL-X, as well as location offset and depth to place people in the scene. The decoder may include a transformer model with cross-attention where the queries correspond to the detected token features (e.g., a query per detected center token) and the keys and values correspond to all image features. This allows an example model to share most computations while attending to every region in the input image.

To account for camera intrinsics, which is useful for reasoning and regressing about 3D, a camera intrinsics encoder for encoding, e.g., Fourier-encoding, the viewing directions from the camera can also be provided. The encoded camera intrinsics can be added to (e.g., concatenated with) each token feature upstream of the decoder.

Example 3D recovery models herein have been demonstrated to achieve strong performance on whole-body and body-only benchmarks simultaneously. Experiments were conducted using example methods, referred to herein as multi-HMR methods. Example Multi-HMR methods notably outperformed existing whole-body methods that require processing multiple high-resolution crops per body part, or hand-designed test-time components for placing people in the scene. Example Multi-HMR methods reached positive results on a wide variety of benchmarks. In experiments evaluating example 3D recovery systems using a ViT-S backbone for the image encoder and 448×448 resolution images, such systems were competitive with other methods in terms of performance, and larger models and higher resolution images provided further performance improvements.

Moreover, example Multi-HMR methods can be relatively efficient compared to other methods. As a nonlimiting example, in experiments training took only 2 days on a single V100 GPU, significantly less than other methods, and ran at 30 fps during inference.

Example 3D recovery models herein may be (but need not be) trained at least in part using synthetic booster datasets. Acquiring high-quality real-world ground truth data at scale for human mesh recovery is costly, particularly when considering faces and hands. This cost can be alleviated by generating large-scale synthetic (synthesized) data. Synthetic booster datasets can include diverse and clearly visible hand poses, seen from a limited distance (e.g., from humans positioned close to a camera), to allow fine details to be captured.

Such datasets can further improve hand pose predictions when added to training of one-stage whole-body prediction such as provided by example 3D recovery models. Experiments with BEDLAM (Black et al., BEDLAM: A synthetic dataset of bodies exhibiting detailed lifelike animated motion, In CVPR, 2023, which is incorporated herein in its entirety) and AGORA (Patel et al., AGORA: Avatars in geography optimized for regression analysis, In CVPR, 2021, which is incorporated herein in its entirety) demonstrate that using large-scale synthetic data can be beneficial for whole-body human mesh regression, as compared to real-world data with pseudo ground-truth fits.

Generated multi-human 3D meshes are useful for various applications. As one example, the ability to condition a motion generation model on both a scene and observed past motion together is useful for robot navigation applications. For instance, an embodied artificial intelligence model can observe human motion and predict possible futures that make sense in a given environment to successfully interact with humans. An example 3D mesh generator configured for this task can be integrated in, for instance, a simulator to allow training mobile robots in an environment with people, such as to avoid contacting people or to interact with people. Capturing faces and hands precisely is also used in applications to virtual or augmented reality (AR/VR), where human body meshes can be directly edited or animated.

As another example, autonomous device (e.g., robot, vehicle) navigation in crowded scenes involves autonomous devices achieving their tasks without perturbing or contacting the people around them. Example 3D mesh recovery models can be integrated, for instance, in a collision avoidance pipeline for a autonomous device to move in crowded environments. Another example application is co-navigation, where an autonomous device may follow or guide a user and determines whether the person is following, paying attention, etc.

Additionally, the ability to understand human poses, gestures and facial expressions may be useful for human-robot Interaction applications. It can also be beneficial for understanding object manipulations or human-human interactions from images or videos. For example, recovered 3D meshes can be analyzed in a downstream task to understand human body language and detect if a person is willing to interact with a robot or not.

### 3D Mesh Recovery Framework and Method

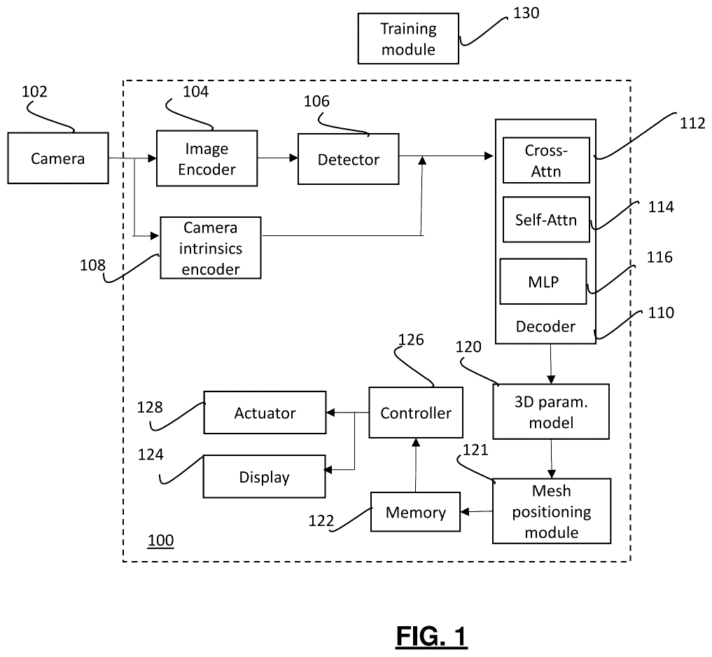

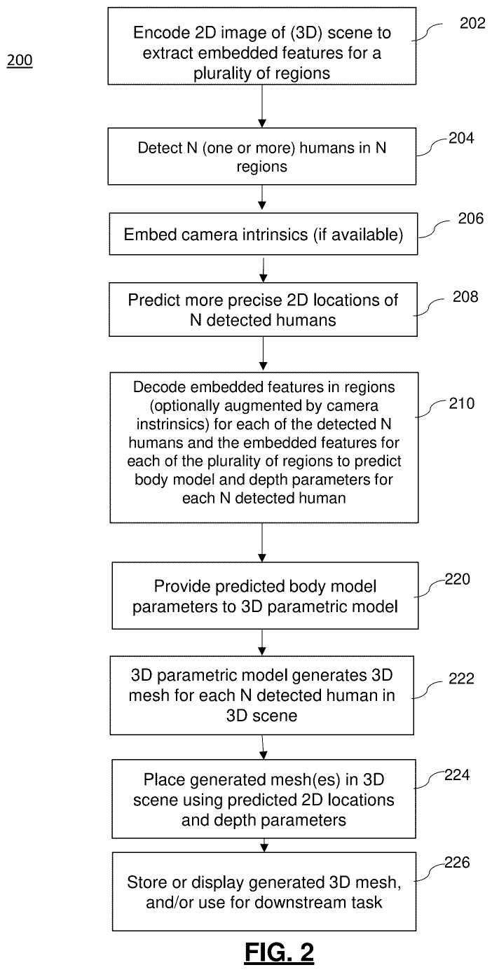

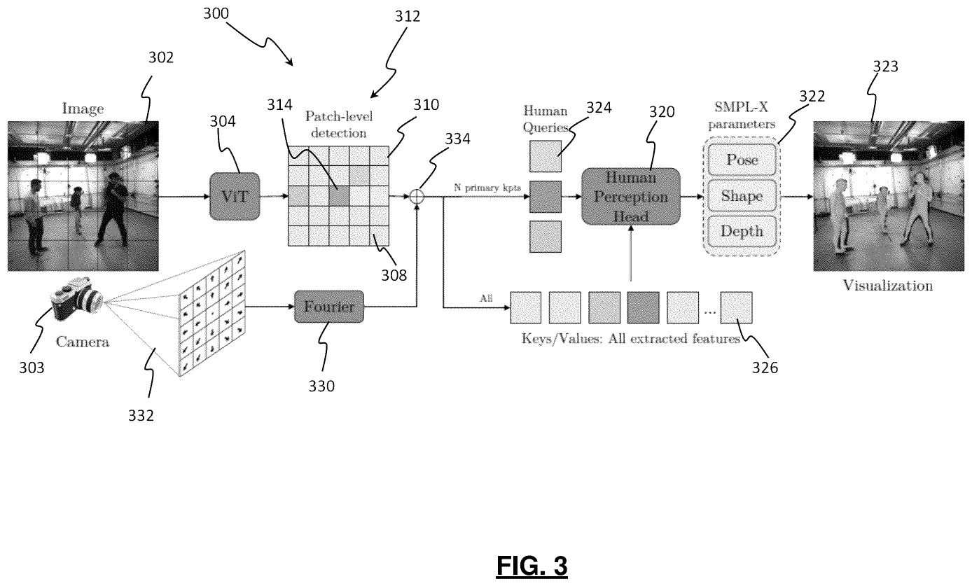

Generally speaking, 3D mesh recovery includes image encoding, detecting humans in the encoded image, and decoding body model parameters and locations from the encoded image to provide inputs for a 3D parametric model. Referring now to the drawings, FIG. 1 shows an example 3D mesh recovery architecture/system 100 that may be implemented in a computing device including one or more processors, such as but not limited to a computer or an autonomous device (e.g., a robot), and FIG. 2 shows an example 3D mesh recovery method 200.

The system 100 receives a 2D image, such as a (internal or external) 2D red/green/blue (RGB) image of a 3D scene, from an image capturing device such as a camera 102 having a field of view (FOV) of the 3D scene. An image encoder 104, such as a trainable image embedding/encoding module, including but not limited to a ViT or a CNN (convolutional neural network), encodes the image at 202 into an encoded image. The encoding includes extracting embedded image features for a plurality of regions in the image. The 2D image, for example, may be divided into a grid of patches, where each region is represented by a patch. The image encoding or embedding may be provided, for instance, as feature tokens, where each feature token represents features in one of the patches on the grid.

A trainable or trained detector module 106 is configured to detect, for each (2D) region in the (2D) grid, whether a human is present at 204. For example, for each feature token, the detector 106 may predict a probability that the token contains a primary keypoint for a human, e.g., a body center such as a head, pelvis, torso, midsection, spine, etc. based on the embedded image features. The detector 106 extracts N detections, representing N humans, such as by thresholding the predictions (e.g., prediction>value=human; prediction<value=no human). Preferably, N is greater than one, providing multi-human detection from a single shot.

At 206, camera intrinsic parameter information related to each region, e.g., as provided by a camera intrinsics encoder module 108, is optionally combined (e.g., concatenated) with the embedded image features for each patch. The camera intrinsics encoder, for instance, may be or include a Fourier encoder.

At 208, which may occur before or after concatenating 206, the detector 106 may further predict a more precise 2D location for each of the N detected humans within the 2D image. To provide a location regression, for each of the N detections, a more exact (or more exact than a center of the region) location of the primary keypoint may be regressed from each respective region where a person was detected into pixel accurate image coordinates using, e.g., a multi-layer perceptron (MLP). For instance, for each region in the 2D grid where a human (e.g., a primary keypoint) was detected, the detector 106 may predict a 2D offset from a center of the region so that the detected 2D location of the human (e.g., of the primary keypoint) can be determined from the 2D location of the region center and the predicted offset.

The embedded image features, optionally augmented by camera intrinsic parameter information (e.g., camera lens focal length and distortion), are input to a trainable or trained decoder module 110. The decoder 110 processes at 210 the embedded image features in the N respective regions and the embedded features for each of the plurality of regions to predict, for each of the N detected humans, body model parameters such as but not limited to pose and shape parameters, as well as depth parameters. For instance, to provide body model parameters, each of the N detections (e.g., embedded image features of the N regions where a human was detected) may be run through a cross-attention module such as a cross-attention block 112 and optionally also a self-attention module such as a self-attention block 114 along with the embedded image features for each of the regions to provide N output features. The N output features can be used to regress N human-centered body model parameters (such as but not limited to pose and shape) and depth parameters for a 3D human mesh, e.g., with one or more shared MLP modules 116 or other MLPs (e.g., shared over the N humans). For instance, the N output features may be used to regress N human-centered whole body parameters to provide (at least) pose, shape, and depth parameters for a whole-body 3D human mesh.

At 220, predicted body model parameters from the decoder 110, e.g., pose and shape parameters, are provided (e.g., output) to a (internal or external) 3D parametric model 120. The 3D parametric model (module) 120 converts at 222 the predicted body model parameters into N 3D human meshes (for N humans in the original image) for placing in camera space. A nonlimiting example 3D parametric model 120 is provided by a SMPL-X model.

At 224, a mesh positioning module 121 places the generated 3D mesh(es) within the 3D scene (e.g., in camera space), such as by using the predicted 2D locations (e.g., centers of 2D grid regions, optionally offset to provide more precise locations) and the depth parameters predicted from the decoder 110.

At 226, the generated 3D human meshes, e.g., with 3D locations, may be stored, e.g., in a non-transitory memory or working memory (e.g., RAM) 122, displayed, e.g., output to a (internal or external) display 124, and/or output to a (internal or external) controller (or control moule) 126 (having memory) for controlling one or more downstream applications/tasks. The downstream applications may be performed, for instance, using the display 124 (e.g., displaying 3D avatars in a virtual environment). Another downstream application is the controller 126 actuating an actuator 128 based on one or more of the 3D human meshes, such as to avoid contacting the 3D human meshes or to mimic one or more of the 3D human meshes. This provides controlled movement of an autonomous device, providing feedback, etc.), or other interface or actuation components.

A training module 130 may be provided externally or internally to the architecture 100 for training learnable components such as the image encoder 104, the detector 106, the camera intrinsics encoder 108 (if trainable), and/or the decoder 110. The training module 130 may, but need not, perform end-to-end training.

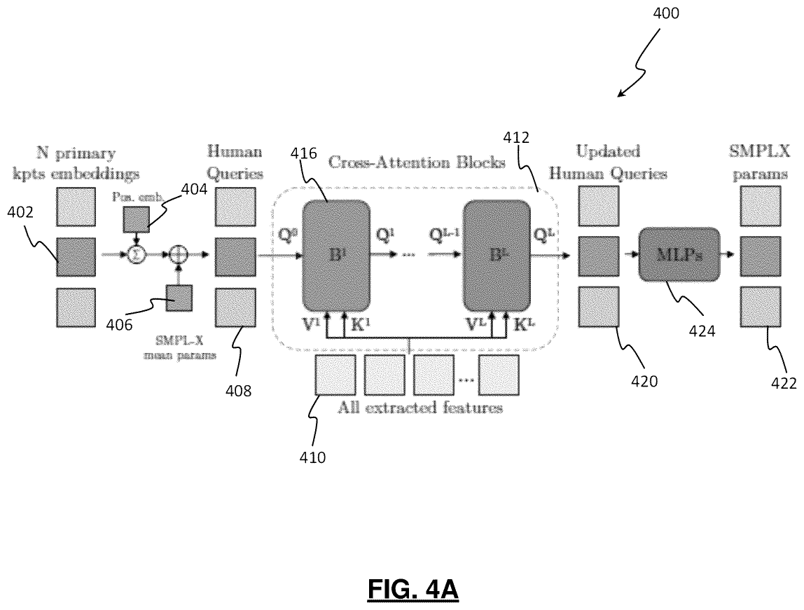

FIG. 3 illustrates operation of a Multi-HMR architecture/system 300 for performing 3D mesh recovery. The Multi-HMR architecture 300 may be an example of the architecture 100. The Multi-HMR architecture 300 can receive input data including a single-shot input, such as a two-dimensional (2D) red/green/blue (RGB) image (2D image) 302, from an image capturing device such as a camera 303.

To extract features from the input data, e.g., embed image features, the example Multi-HMR architecture 300 may include a trainable image embedding module 304 (an example of the image encoder 104), such as including a neural backbone. The image embedding module 304 may be or include, for example, a Vision Transformer (ViT). An example Vision Transformer is disclosed in Dosovitskiy et al., An image is worth 16×16 words: Transformers for image recognition at scale, In ICLR, 2021, which is incorporated herein in its entirety. Other example trainable image embedding modules include but are not limited to convolutional neural networks (CNN).

A ViT can include pretraining, e.g., large-scale self-supervised pretraining, such as disclosed in Caron et al., Emerging properties in self-supervised vision transformers, In ICCV, 2021, He et al., Masked autoencoders are scalable vision learners, In CVPR, 2022, or Oquab et al., Dinov2: Learning robust visual features without supervision. arXiv preprint arXiv:2304.07193, 2023, each of which is incorporated herein in its entirety. However, the image embedding module 304 may be embodied in or include other Vision Transformers or other backbone architectures.

The image embedding module 304 receives the input data, e.g., 2D RGB image 302, and extracts an image embedding. The image embedding may be or include a feature tensor, which provides respective feature tokens for each patch, e.g., patches 308 in a grid 310 of patches representing the image.

For detecting humans in the embedded 2D image, a patch-level detector module 312, e.g., detector 106, may regress a person-center heatmap, e.g., in grid 310, from the feature tensor generated by the image embedding module 304. In an example regression method, for each input feature token (token representing features in each patch or region 308), the patch-level detector outputs a prediction, e.g., a probability, that a person is centered on a point, referred to herein as a primary keypoint, that is present in the corresponding input patch. The patch-level detector 312 may further predict a location of the primary keypoint relative to the patch center, e.g., by predicting a location offset.

N humans in the image 302, associated with N primary keypoints, can be detected, such as by thresholding the probabilities for each input patch. An example patch-level detector 312 may be or include a framework analogous to the CenterNet object detection framework disclosed in Zhou et al., Objects as points, In arXiv preprint arXiv:1904.07850, 2019, which is incorporated herein in its entirety. For example, in FIG. 3, three primary keypoints, an example of which is indicated at 314, in three respective patches 308 on the grid 310 are detected, and thus N=3. This illustrates that the patch-level detector 312 can perform multi-human detection using a single 2D image 302.

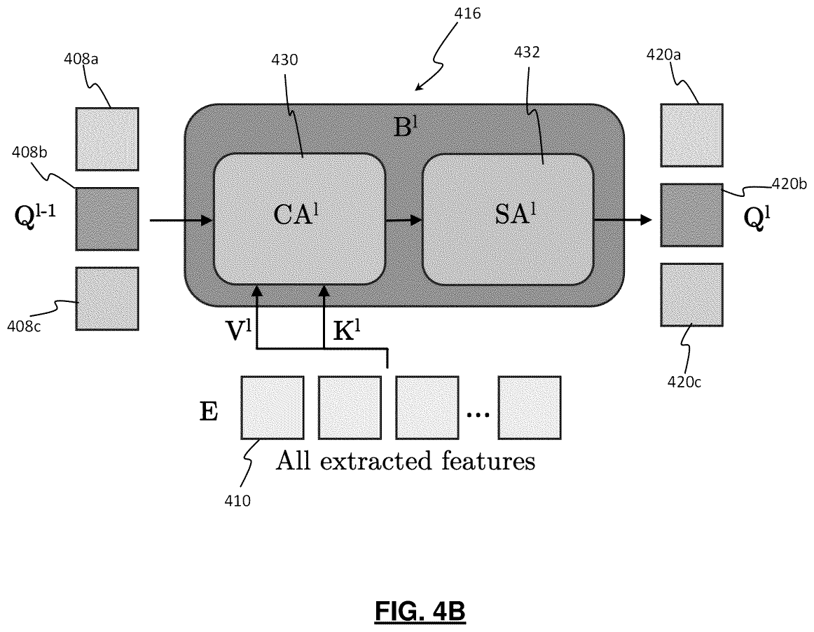

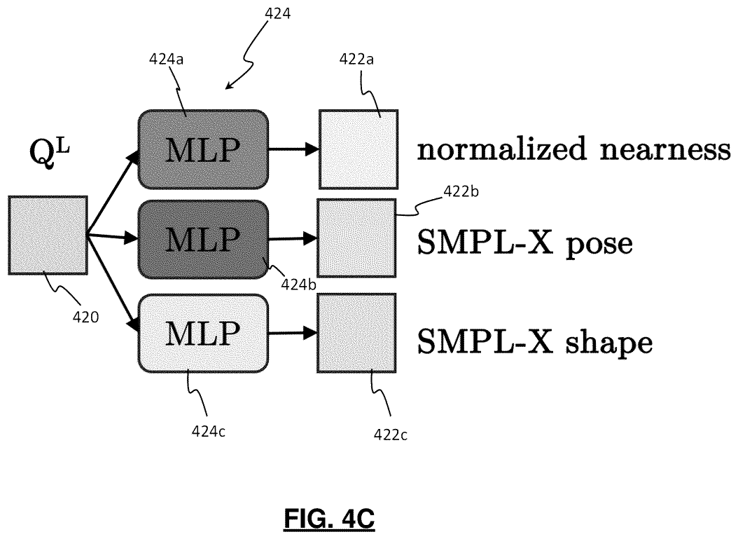

The patch-level detector 312 feeds into a prediction head embodied in a human perception head 320, which is an example of the decoder 110. The human perception head 320 includes a cross-attention module, further details of which are disclosed below regarding FIGS. 4A-4C.

The human perception head (module) 320 is configured to predict parameters 322 including, for instance, body model parameters such as pose and shape parameters for an expressive 3D human parametric coding model (e.g., body, hands, face, etc.) for each detected person, as well as depth to place people in a scene (e.g., as shown in visualization 323). A nonlimiting example 3D human parametric coding model is embodied in a SMPL-X model, as disclosed in Choutas et al., Monocular expressive body regression through body-driven attention, In ECCV, 2020, which is incorporated herein in its entirety.

An example human perception head 320 includes transformer blocks with cross-attention, where the queries 324 correspond to the N detected tokens (and may thus be referred to as “human queries”) and the keys and values 326 are computed from the extracted features in all regions of the image. Such a cross-attention model can allow for most computations to be shared between the (human) queries 324 while attending to every region in the input image 302, though it is possible that fewer regions may be attended to. In this way, the cross-attention module can cross-attend to the entire image to regress features that are not directly shown in the received 2D image. Nonlimiting examples of transformer blocks with cross-attention are disclosed in U.S. Pat. No. 10,452,978, and in Vaswani et al., Attention is All You Need, Advances in Neural Information Processing Systems 30 (NIPS 2017), arXiv: 1706.03762, which is incorporated herein in its entirety.

To account for camera intrinsics, the Multi-HMR architecture 300 may further include a camera feature embedding module (an example of the camera intrinsics encoder 108) embodied in a Fourier encoding module 330. The Fourier encoding module 330 generates a Fourier encoding of the rays 332 (e.g., of the corresponding camera ray directions) going from the camera 303 center. This encoding provides a camera feature embedding that is combined, e.g., concatenated at 334, with the image feature embedding from the patch-level detection 312 upstream of the human perception head 320.

The embedded camera features can enhance each token feature of the image feature embedding. For instance, the cross-attention module in the human perception head 320 may consider the entire grid 310, updated with camera parameters generated from the Fourier encoding module 330, such that an example grid includes, e.g., for each region (or patch), embedded image features from the image encoder (patch-level detection 312) concatenated with features from the camera intrinsics.

Unlike other mesh recovery approaches, example 3D recovery models herein need not rely on additional inputs such as multi-resolution crops of body parts for expressive models, nor hand-designed components to place people in a scene. In this way, example 3D recovery models can be made more efficient than models under existing approaches.

### Multi-HMR Model

The example Multi-HMR features discussed herein provide multi-person single-shot (or single-stage) 3D human mesh recovery, e.g., whole-body 3D human mesh recovery. Additional features of a 3D recovery model such as the Multi-HMR model will now be described in further detail with reference to FIGS. 3 and 4A-4C.

Given an input (e.g., from a camera 303) RGB image I∈ [symbol] ^{H×W×3} (e.g., 2D image 302) with resolution H×W and a camera intrinsic matrix K∈ [symbol] ^{3×3}, an example 3D recovery model, denoted [symbol] , outputs (e.g., directly outputs) a set of N centered whole-body 3D humans meshes M∈ [symbol] ^{V×3} together with 3D spatial locations t∈ [symbol] ³ in the camera coordinate system:

$${\{ {M}_{n} + {t}_{n} \}}_{n ∈ \{ 1 , … , N \}} = ( I , K ) . \qquad ( 1 )$$

### Human Whole-Body Mesh Representation Model:

An example 3D human mesh recovery employs a parametric 3D body model. A nonlimiting example parametric 3D body model is SMPL-X (Choutas et al., Monocular expressive body regression through body-driven attention, In ECCV, 2020, which is incorporated herein in its entirety), which can represent the human body with controllable face and hands. Given input parameters for the pose θ∈ [symbol] ^{53×3} (global orientation, body, hands, and jaw poses) expressed using axis-angle representation, shape β∈ [symbol] R¹⁰, and facial expression α∈ [symbol] ¹⁰, the SMPL-X model outputs an expressive human-centered 3D mesh M=SMPL−X(θ,β,α)∈ [symbol] ^{V×3}, with V=10475 vertices.

The example mesh M can be centered around a primary keypoint, such as a body center, to center the human 3D representation. A keypoint can be selected, though it is also contemplated that predetermined keypoints may be selected by default. In an illustrative example herein the primary keypoint is selected to be the head. In other examples, the primary keypoint can be the pelvis or other location. Keypoints J may be a linear combination of the vertices and may be computed as J=MW, where W is a fixed regressor matrix.

The primary keypoint can be placed in the 3D scene by translating the primary keypoint by a 3D translation t. Put another way, a translation t of a human in a scene may be expressed as the 3D position of the primary keypoint from the camera.

For explanation, let x=[θ,β,α]. The problem can be expressed as predicting x and t for all detected humans. An example 3D recovery model thus predicts for each person human-centered SMPL-X (or other 3D parametric model) parameters x and 3D translation t, e.g., expressed in the camera coordinate system.

### Camera Model:

Including the camera intrinsic parameters decreases prediction uncertainty when estimating 3D poses and positions in the 3D scene. Although other camera models may be considered, an example method assumes a simple pinhole camera model to project points in the 3D space into the image plane. For sake of simplicity of explanation, and ignoring distortion, the camera 303 may be defined by an intrinsic matrix K (e.g., K∈ [symbol] ^{3×3}) with focal length f (or field of view (FOV)) and principal point parameters (pᵤ,pᵥ). An example projection model can assume, for instance, a pinhole camera model and denote an intrinsic matrix input. Focal length f can also be derived from FOV, or vice versa. If K is not available for a particular camera, a library, such as but not limited to SPEC-CamCalib, may be used to provide an estimate for K. Focal lengths or FOVs may be retrieved for use, computed online or in real-time, or provided using a combination of retrieved and computed parameters.

The camera pose may be (for example) set to the origin. Let t=(tₓ,t_{y},t_{z}) be a 3D point. This can provide:

$$K = [ \begin{matrix}f & 0 & {p}_{u} \\ 0 & f & {p}_{v} \\ 0 & 0 & 1\end{matrix} ] and \{ \begin{matrix}{[ {c}_{u} , {c}_{v} , 1 ]}^{T} = ( 1 / {t}_{z} ) \cdot {K [ {t}_{x} , {t}_{y} , {t}_{z} ]}^{T} \\ {[ {t}_{x} , {t}_{y} , {t}_{z} ]}^{T} = ( {t}_{z} ) \cdot {{K}^{- 1} [ {c}_{u} , {c}_{v} , 1 ]}^{T}\end{matrix} , \qquad ( 2 )$$

where c=(cᵤ,cᵥ) represents the 2D image coordinates of the projection of t into the image plane. The camera intrinsic matrix K can thus be used to backproject a 2D point in the image into a 3D point given t_{z}, which is the depth at a given pixel. One can denote by π_{K} the camera projection operator and

$${π}_{K}^{- 1}$$

the camera inverse projection operator.

### Single-Shot Architecture

The example 3D recovery architecture, e.g., Multi-HMR architecture 300, performs a single-shot (or one-stage) 3D projection method for multiple humans in a scene captured in an image. Generally, the ViT-based image embedding module 304 encodes images 302 from the camera 303 into token embeddings, e.g., representing a grid 310 of patches 308 making up the image. The patch-level detector 312 processes these token embeddings to detect humans. The token embeddings (in this example) are combined via concatenation 334 with camera embeddings from Fourier encoding module 330, and the (e.g., combined) token embeddings are used as human queries 324 and keys/values 326 by the human perception head 320 to regress whole-body human meshes and depth parameters 322. The Human Perception Head 320 may be trained, for instance, from scratch.

An example operation of the Multi-HMR architecture 300 will now be described in more detail.

### Image Embedding:

The input RGB image I may be encoded with the ViT-based image embedding module 304, such as the backbone described in Dosovitskiy et al., An image is worth 16×16 words: Transformers for image recognition at scale, In ICLR, 2021, which is incorporated herein in its entirety. For example, the image may be sub-divided by the embedding module 304 into a grid 310 of image patches 308 of size P×P, each embedded into tokens with a (e.g., learned) linear transformation and positional encoding. For clarity of explanation, for an input RGB image I∈ [symbol] ^{H×W×3} it may be assumed that H and W are divisible by P to subdivide the image into image patches of size P×P, but if not, the sub-division may be otherwise configured. The set of tokens may be processed with self-attention blocks into an embedded image E_{I}∈ [symbol] ^{H/P×W/P}XD with D the feature dimension (feature vector). An example ViT model may keep a constant resolution throughout, so that each output token can spatially correspond to a patch in the input image.

### Patch-Level Detection:

To detect humans in the input image 302, an example 3D projection method performed by the patch-level detector 312 can be configured generally similarly to the CenterNet paradigm, as disclosed for instance in Zhou et al., Objects as points, In arXiv preprint arXiv:1904.07850, 2019, which is incorporated herein in its entirety. Since, for instance, a person can belong to multiple patches in the image an example method considers a primary keypoint. As provided above, a primary keypoint on human bodies may be selected or predetermined by default, a non-limiting example of which being the head, though other choices are possible, such as the pelvis, etc.

For each patch index (i,j)∈{1, . . . , H/P}×{1, . . . , W/P}, the example patch-level detector 312 predicts whether the patch centered at u^{i,j}=(uⁱ,v^{j}) contains a primary keypoint, for instance using a score s^{i,j}∈[0,1] (or other scale), which score may be computed by the patch level detector 312 from the associated token embedding

$${E}_{I}^{i , j} ∈ {ℝ}^{D} , e . g . ,$$

using a Multi-Layer-Perceptron (MLP).

At inference, a threshold T (a nonlimiting example being 0.5, though this can be higher or lower) may be applied to the scores to detect patches containing primary keypoints, e.g., to provide a binary decision, such as described by:

$${\{ {u}_{n} \}}_{n} = \{ {u}^{i , j} \vert {s}^{i , j} \geq τ \} . \qquad ( 3 )$$

At training, the ground-truth detections may be used for the rest of the model. The MLP may be shared across each token, and a score map S may be obtained indicating at each location (i,j) if a human is detected. The score map can be obtained for the entire image, and by applying a threshold on the scores only patches where a primary keypoint is detected may be kept, e.g., the three patches 314 identified in the example grid 310 in FIG. 3.

### Image Coordinates Regression:

Detecting people at the patch-level yields a rough estimation of the 2D location of the primary keypoint (projected into the camera plane), up to the size of the predefined patch size P. For illustration, a nonlimiting example patch size is 14 pixels (in each of W and H directions), though this number may be greater or smaller. Example methods can further refine the 2D location of the primary keypoint from the center of a patch (uⁱ,v^{j}) by regressing a residual offset δ=(δᵤ,δᵥ) from the corresponding token embedding

$${E}_{I}^{i , j}$$

using an MLP. The final pixel coordinates of the primary keypoint detected at patch location (i,j) may be given by:

$${c}^{i , j} = [ {u}^{i} + {δ}_{u} , {v}^{j} + {δ}_{v} ] . \qquad ( 4 )$$

For example, if N patches each contain a primary keypoint, an example method can output N 2D camera coordinates {c}_{1 . . . N} which correspond to the pixel location of N primary keypoints.

To place the primary keypoint in the 3D scene, expressed in the camera coordinate system, cᵢⱼ may be unprojected using the depth of the primary keypoint d:

$$t = {{K}^{- 1} [ {u}_{i} + {δ}_{u} , {v}_{j} + {δ}_{v} , d ]}^{T}$$

### Camera Embedding:

Since both RGB image and camera information can play a useful role for understanding the 3D environment, camera information may be used as additional input to the perception module, e.g., Human Perception Head 320. Camera information may be separately embedded, for instance, by computing the ray direction r_{i,j}=K⁻¹[uᵢ,vⱼ,1]^{T} from each patch center (uᵢ,vⱼ), such as by using the method disclosed in Mildenhall et al., Nerf: Representing scenes as neural radiance fields for view synthesis, In ECCV, 2020, which is incorporated herein in its entirety.

The first two values of the r_{i,j} vector may be kept, optionally L₂ normalized, and embedded into a high-dimensional space using Fourier encoding, such as disclosed in Mildenhall et al., 2020, which is incorporated herein in its entirety, to obtain a patch-level geometric embedding E_{K}∈ [symbol] ^{H/P×W/P×2(F+1)}, where F is the number of frequency bands. Extracted features may be concatenated with camera embeddings to get E=E₁⊕E_{K}, where ⊕ denotes concatenation along the channel axis. If the camera intrinsics matrix is unknown, the field of view may be set to a default number, for instance, 60 degrees, and the principal point to the image center.

### Human Perception Head:

Example methods predict human-centered meshes and depths for all people detected in the scene in a structured manner and in parallel, by processing E with a decoder. An example decoder is embodied in the Human Perception Head 320, including cross-attention blocks, e.g., as disclosed in Jaegle et al., Perceiver: General perception with iterative attention, In ICML, 2021.

FIGS. 4A-4C illustrate features and functionality of a Human Perception Head 400, which is an embodiment of the Human Perception Head 320. The Human Perception Head 400 allows features corresponding to a person detection to attend information from all image patches before making a full pose, shape, and depth prediction for this person. In this way, human properties for all detected humans may be estimated all at once using a cross-attention based prediction head, providing efficient decoding.

In example methods, there may be as many input queries to the cross-attention mechanism as detected humans, while keys and values may come from E. Such an example framework is well suited to a structured set prediction task. For example, given N detected humans, an example method initializes N cross-attention queries {qₙ}ₙ.

Assuming qₙ 402 was detected at patch (i,j), then qₙ=(E^{i,j}⊕x̅)+p^{i,j} where p^{i,j} is a learned query initialization 404, dependent on position, and x̅ denotes the mean body model parameters 406, of dimension D′, similar to that disclosed in Goel et al., Humans in 4d: Reconstructing and tracking humans with transformers, In ICCV, 2023; and Kolotouros et al., Learning to reconstruct 3d human pose and shape via model-fitting in the loop, In ICCV, 2019, which are each incorporated herein in its entirety. The queries 408 may be stacked into Q⁰∈ [symbol] ^{(D+D)×N} for efficient processing in parallel. For instance, FIG. 4B shows stacked input queries 408a, 408b, 408c for N=3. The full feature tensor E is used as cross-attention keys and values 410, so that predictions may be made from the full image.

The queries 408 are then updated with a stack 412 of L blocks B^{l} 416 (as a nonlimiting example, L=2), alternating between a cross-attention layer (CA) over queries and features and a self-attention layer (SA) over queries:

$${Q}^{l} = {B}^{l} ( [ {Q}^{l - 1} , E ] ) = S {A}^{l} ( C {A}^{l} [ {Q}^{l - 1} , E ] ) . \qquad ( 5 )$$

FIG. 4B shows an example block B^{l} 416 including a cross-attention layer CA^{l} 430 that outputs to a self-attention layer SA^{l} 432. The cross-attention layer CA^{l} 430 processes over queries Q^{l-1} and features represented by key and value pairs V^{l},K^{l} from extracted features E 410, while the self-attention layer SA^{l} 432 processes over queries. Example features of cross-attention and self-attention blocks 430, 432 are disclosed in U.S. Pat. No. 10,452,978, and in Vaswani et al., 2017, which is incorporated herein in its entirety.

The final outputs 420 of the cross-attention module 412 are given by Q^{L}∈ [symbol] ^{(D+D′)×N} and may be viewed as a set of N output features, e.g., output features 420a, 420b, 420c in FIG. 4B. The output features are used to regress N human-centered whole-body parameters {xₙ}ₙ 422 with MLPs 424. This provides an expressive human-centered mesh M for each query.

FIG. 4C shows an example regression method for an updated query Q^{L} 420. The updated query Q^{L} 420 is input to different multilayer perceptrons (MLPs) 424a, 424b, 424c for regressing parameters for depth (e.g., normalized nearness) 422a, SMPL-X pose 422b, and SMPL-X shape 422c for each of N humans. The pose and shape parameters to be predicted may depend on the 3D parametrization model, and will be appreciated by an artisan. An example depth parametrization, normalized nearness will now be described.

### Depth Parametrization:

Similar to approaches for monocular depth (e.g., Mertan et al., Single image depth estimation: An overview, Digital Signal Processing, 2022; and Weinzaepfel et al, CroCo v2: Improved cross-view completion pretraining for stereo matching and optical flow, In ICCV, 2023, which are each incorporated herein in its entirety), the depth d can be predicted in log-space (also called nearness, denoted v). Since depth estimation can depend on camera parameters (e.g., focal length, FOV, etc.), example methods regress a normalized nearness \hat{η} from Q^{L} using an MLP, assuming a standard focal length \hat{f}:

$$\{ \begin{matrix}η = \frac{\hat{f}}{f} \hat{η} \\ d = exp ( - η )\end{matrix} \qquad ( 6 )$$

This parametrization improves robustness to changes in the focal length f (e.g., as suggested by Facil et al., Camconvs: Camera-aware multi-scale convolutions for singleview depth. In CVPR, 2019, which is incorporated herein in its entirety).

### Inference:

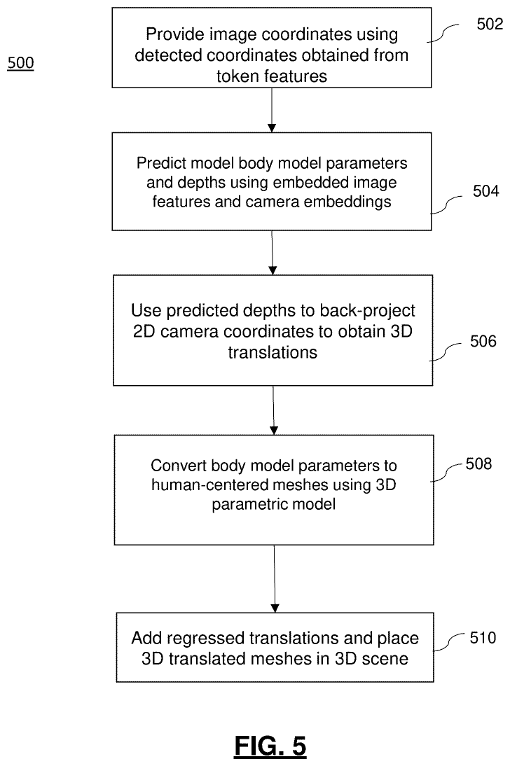

FIG. 5 shows an example inference method 500. In an example inference method using Multi-HMR, detected coordinates {uₙ}ₙ obtained from token features E, following Equation (3) are refined at 502 into images coordinates {cₙ}ₙ following Equation (4) discussed above.

At 504, image features E_{I} and camera embeddings E_{K} are used to predict body model parameters {xₙ}ₙ and depths {dₙ}ₙ following Equation (6). At 506, the predicted depths can be used to back-project the 2D camera coordinates {cₙ}ₙ using the camera inverse projection operator

$${π}_{K}^{- 1}$$

following Equation (2) to obtain the 3D translations {tₙ}ₙ of primary keypoints.

At 508, body model parameters are converted to human-centered whole-body (for instance) meshes {Mₙ}ₙ using the SMPL-X model (an example of the 3D parametric model 120). At 510, the final outputs {Mₙ+tₙ}ₙ are placed in the scene by adding the regressed translations. Back-projecting 506 and/or placing 510 may be performed, for instance, by the mesh positioning module 121.

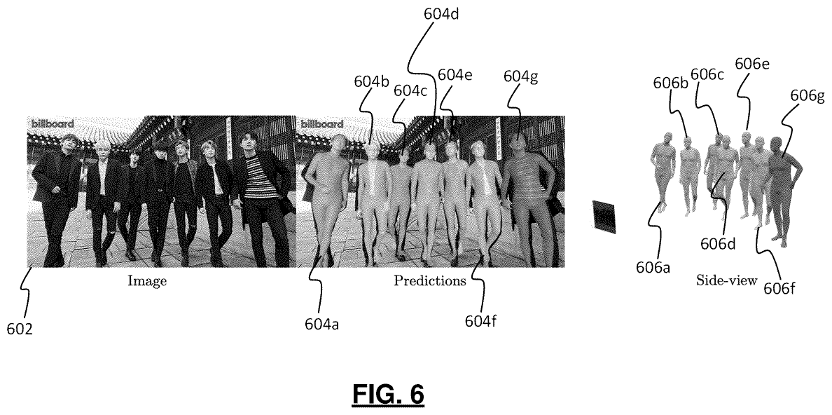

FIG. 6 shows an example input 2D image 602 (left), along with predicted 3D whole-body human 3D meshes 604a-604g (N=7 in this example). Example side-views 606a-606g of the seven generated whole-body 3D meshes is also illustrated (right).

### Training:

Example 3D mesh recovery methods can be fully-differentiable and trained end-to-end by back-propagation. Example training losses will now be discussed. A tilde ˜ denotes ground-truth targets.

### Detection Loss:

For detection loss, the ground-truth primary keypoint of each human present in the image may be projected using, for instance, the camera projection operator π_{K}, and a score map S of dimension (W/P)×(H/P) can be constructed with S^{i,j} equal to 1 if a primary keypoint is projected to the corresponding patch and 0 otherwise. Predictions can be trained by a training module adjusting one or more parameters of the model based on minimizing a binary cross-entropy loss:

$${ℒ}_{d e t} = - {\sum }_{i , j} {\tilde{s}}^{i , j} log ( {s}^{i , j} ) + ( 1 - {\tilde{s}}^{i , j} ) log ( 1 - {s}^{i , j} ) . \qquad ( 7 )$$

### Regression Losses:

All other quantities predicted by the model may be trained with, for instance, L₁ regression losses. Example methods concatenate the offset from the patch centers c, the body model parameters (pose, shape, expression) \tilde{x} (e.g., using methods similar to those disclosed in Goel et al., Humans in 4d: Reconstructing and tracking humans with transformers. In ICCV, 2023.; and Kolotouros et al., Learning to reconstruct 3d human pose and shape via model-fitting in the loop, In ICCV, 2019, which are incorporated herein in their entireties) as well as the depth \tilde{d}, and minimize [symbol] ₚₐᵣₐₘₛ=Σₙ|[c,x,d]−[\tilde{c},\tilde{x},\tilde{d}]|. It is also beneficial (e.g., to speed up convergence) to minimize an L₁ loss for human-centered output meshes [symbol] ₘₑₛₕ=Σₙ|Mₙ−\tilde{M}ₙ|, as well as for the reprojection of the mesh expressed in camera coordinates space into the image plane [symbol] ᵣₑₚᵣₒⱼ=Σₙ|π_{K}(Mₙ+tₙ)−π_{K}(\tilde{M}ₙ+\tilde{t}ₙ)|.

The final example training loss is thus (with weighting parameter A, which may depend on the number of vertices considered, the units used for camera coordinates, or other factors):

$$ℒ = {ℒ}_{de t} + {ℒ}_{params} + λ ( {ℒ}_{m e s h} + {ℒ}_{r e p r o j} ) . \qquad ( 8 )$$

### Synthetic Whole-Body Data:

In example methods, synthetic data may be configured to contain i) diverse hand poses and ii) close-up views of clearly visible hands. Synthetic data may be rendered, for instance, using Blender (https://www.blender.org/) synthetic human models close to the camera in poses sampled from the BEDLAM dataset (Black et al, BEDLAM: A synthetic dataset of bodies exhibiting detailed lifelike animated motion, In CVPR, 2023), AGORA (Patel et al., AGORA: Avatars in geography optimized for regression analysis, In CVPR, 2021), and UBODY (Li et al., Cliff: Carrying location information in full frames into human pose and shape estimation, In ECCV, 2022) datasets, using additional hand poses from InterHand (Moon et al., Interhand2. 6m: A dataset and baseline for 3d interacting hand pose estimation from a single RGB image, In ECCV, 2020) for increased diversity, all of which are incorporated herein in its entirety. A total of 73k images were generated for experiments. Simply adding this data to the training was shown to improve the quality of hand pose predictions, without degrading other metrics.

### Experiments

In experiments, example Multi-HMR models were evaluated on various benchmarks, including both body-only mesh recovery datasets such as 3DPW (von Marcard et al., Recovering accurate 3d human pose in the wild using imus and a moving camera. In ECCV, 2018), MuPoTs (Mehta et al., Single-shot multi-person 3d pose estimation from monocular RGB. In 3DV, 2018), CMU-Panoptic (Joo et al., Panoptic studio: A massively multiview system for social motion capture, In ICCV, 2015), AGORA-SMPL (Patel et al., AGORA: Avatars in geography optimized for regression analysis. In CVPR, 2021), as well as whole-body mesh recovery datasets such as EHF (Pavlakos et al., Expressive body capture: 3d hands, face, and body from a single image, In CVPR, 2019), AGORA-SMPLX (Patel et al., 2021), and UBody (Lin et al, One-stage 3d whole-body mesh recovery with component aware transformer. In CVPR, 2023).

Using a ViT-S backbone and 448×448 image inputs, example Multi-HMR models matched the performance of other approaches on both body-only and whole-body benchmarks. An example Multi-HMR model allowed for real-time applications with 30 frames per second inference speed on a single V100 GPU, and training took about two days on a single V100 GPU, which was significantly faster than most methods. Larger backbones and higher resolutions, e.g., up to a ViT-L backbone and 896×896 backbone, was shown to significantly improve performance over state-of-the-art approaches, at the cost of slower inference.

Additional experiments supplemented the training data of example Multi-HMR models with a synthetic booster dataset that contained images of people close to a camera, with diverse and expressive hand poses. The additional training data further improved performance on hand predictions.

### Datasets and Metrics

The BEDLAM dataset is a large-scale multi-person synthetic dataset composed of 300k images for training including diverse body shapes, skin tones, hair and clothing. Synthetic humans are built by using a SMPL-X mesh and adding some assets such as clothes and hair. In each scene there are from 1 to 10 people with diverse camera viewpoints. The test set is composed of 16k images.

The AGORA dataset is a multi-person high realism synthetic dataset which contains 14k images for training, 2k images for validation and 3k for testing. It includes 4,240 high-quality humans scans each fitted with accurate SMPL and SMPL-X annotations. Results on the test set are obtained using an online leaderboard for SMPL and SMPL-X results. Results on the validation for the distance estimation are also provided since the leaderboard does not give this metric on the test set.

The 3DPW dataset is an outdoor multi-person dataset composed of 60 sequences which contain respectively 17k images for training, 8k images for validation and 24k images for testing. This has been the first in-the-wild dataset in this domain for evaluating body mesh reconstruction methods.

The MuPoTs dataset is an outdoor multi-person dataset captured in a multi-view setting. The dataset is composed of 8k frames from 20 real-world scenes with up to three subjects. This dataset was used for evaluation. Poses are annotated in 3D with 14 body joints.

The CMU Panoptic dataset is a large-scale controlled environment multi-person dataset captured by multiple cameras. Each person is annotated with 14 joints in 3D. Four sequences were used, which leads to a test set composed of 9k images.

The EHF dataset is an evaluation dataset for SMPL-X based models. It was built using a scanning system followed by a fitting of the SMPL-X mesh. It is a single person whole-body pose dataset composed of 100 images.

The UBody dataset (Lin et al, One-stage 3d whole-body mesh recovery with component aware transformer, In CVPR, 2023) is a large-scale dataset covering a wide range of real-life scenarios such as fitness videos, VLOGs or sign language. Most of the time only the upper body part of the persons is visible. The inter-scene protocol was used where there are 55k images for training and 2k images for testing.

### Metrics Descriptions:

Multi-person human mesh recovery proposed metrics can be separated into three categories: i) metrics that evaluate the reconstruction of the human mesh, centered around the root joint; ii) metrics that evaluate detection and iii) metrics that evaluate the prediction of spatial location.

### Human-Centered Mesh Metrics:

To evaluate the predicted human mesh, experiments centered both estimated and ground-truth human meshes around the pelvis joint. They use per-vertex error (PVE) to evaluate the accuracy of the entire 3D mesh. When available, PVE computed on vertices corresponding to the face and hands only (PVE-Face and PVE-Hands) was also reported. Because global orientation mistakes heavily impact the PVE, prediction quality was also assessed without taking the global orientation into account by reporting all these metrics after Procrustes-Alignment (denoted with the prefix PA). Since some human body datasets do not have mesh ground-truths but only 3D keypoints, Mean Per Joint Position Error (MPJPE) was also reported on the 14 LSP 3D keypoints as well as the Percentage of Correct Keypoints (PCK) using a threshold of 15 cm.

### Detection Metrics:

To evaluate detection experiments relied on the Recall, Precision and F1-Score metrics. On some datasets, normalized mean joints error (NMJE) and normalized mean vertex error (NMVE) may be reported, which are obtained by dividing mean joint errors and mean vertex errors by the F1-Score. This produces a score sensitive to both reconstruction quality and detection.

### Spatial Location Metrics:

To evaluate distance predictions the Mean Root Position Error (MRPE) was used by using the pelvis as root (primary) keypoint.

### Implementation Details:

An example method by default used squared input images of resolution 448×448, with the longest side resized to 448 and the smallest zero-padded to maintain aspect ratio. Only random horizontal flipping was used as data augmentation, though additional, or more complicated data augmentations schemes may be used (but may not always bring significant gains).

The weights of the backbone were initialized with DINOv2, as disclosed in Oquab et al., 2023. Experiments used Small, Base and Large ViT models, which is incorporated herein in its entirety, as encoder. Experiments uses a batch-size of 8 images, and an initial learning rate of 5e-5, and the example model was trained with automated mixed precision (Micikevicius et al., Mixed precision training, In ICLR, 2018, which is incorporated herein in its entirety) for 400k iterations. At resolution 448×448, training a ViT-S (resp. ViT-L) took around 2 (resp. 5) days on a single NVIDIA V100. The default detection threshold was τ=0.5. Experiments used the neutral SMPL-X model with 10 shape components.

### Evaluation Benchmarks:

Because example 3D recovery methods uniquely can be used to provide single-stage multi-person whole-body human mesh recovery, example methods were evaluated on both body only benchmarks and whole-body benchmarks to compare against other works.

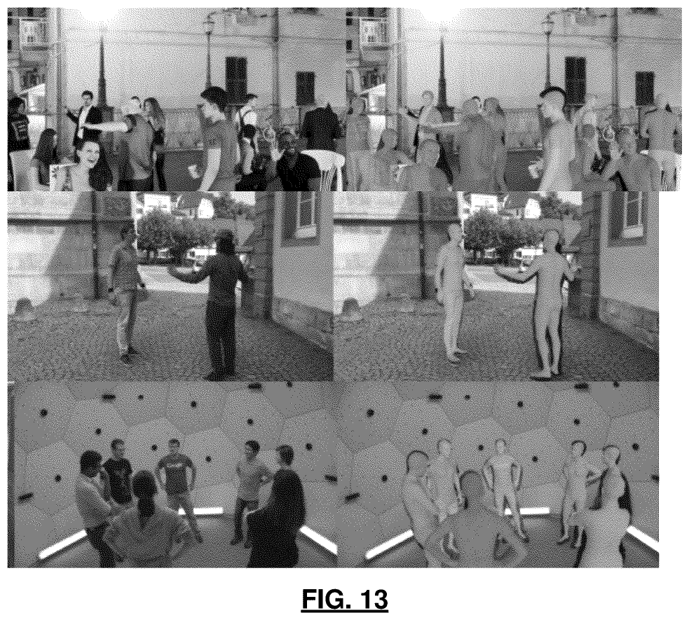

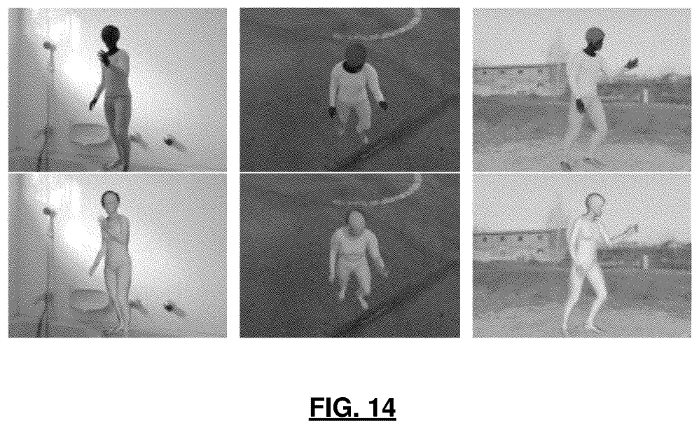

For body-only benchmarks, experiments predicted SMPL meshes from SMPL-X meshes using the regressor from Black et al., 2023, and follow (Lin et al., One-stage 3d whole-body mesh recovery with component aware transformer, In CVPR, 2023; Moon et al., Accurate 3d hand pose estimation for whole-body 3d human mesh estimation, In CVPR Worskhop, 2022; Qiu et al., Psvt: End-to-end multi-person 3d pose and shape estimation with progressive video transformers, In CVPR, 2023; Sun et al., Monocular, one-stage, regression of multiple 3d people, In ICCV, 2021; Sun et al., Putting people in their place: Monocular regression of 3d people in depth. In CVPR, 2022, each of which is incorporated herein in its entirety) in evaluating on 3DPW (von Marcard et al., 2018), MuPoTs (Mehta et al., Single-shot multi-person 3d pose estimation from monocular rgb. In 3DV, 2018), CMU (Joo et al., Panoptic studio: A massively multiview system for social motion capture, In ICCV, 2015) and AGORA (Patel et al., AGORA: Avatars in geography optimized for regression analysis. In CVPR, 2021). Example qualitative examples (visualizations) are shown in FIGS. 12-13, including the input image and example results from Multi-HMR overlaid on the image. FIG. 12 shows images from EHF (top), MuPoTs (middle), and UBody (bottom). FIG. 13 shows images from AGORA (top), 3DPW (middle), and CMU (bottom).

For whole-body evaluation, performance of example 3D recovery models was compared to prior work (Feng et al., Collaborative regression of expressive bodies using moderation, In 3DV, 2021; Lin et al., One-stage 3d whole-body mesh recovery with component aware transformer, In CVPR, 2023; Moon et al., Accurate 3d hand pose estimation for whole-body 3d human mesh estimation, In CVPR Worskhop, 2022) on EHF (Pavlakos et al., Expressive body capture: 3d hands, face, and body from a single image. In CVPR, 2019), AGORA, and UBody, although such methods are single-person only and therefore not directly comparable.

### Evaluation Metrics:

Standard metrics (Lin et al., One-stage 3d whole-body mesh recovery with component aware transformer, In CVPR, 2023; Sun et al., Monocular, one-stage, regression of multiple 3d people. In ICCV, 2021; Sun et al., Putting people in their place: Monocular regression of 3d people in depth, In CVPR, 2022) were reported with the per-vertex error (PVE) to evaluate the accuracy of the entire 3D mesh as well as of specific body parts (hands and face). When the entire ground-truth mesh was not available, the Mean Per Joint Position Error (MPJPE) and the Percentage of Correct Keypoints (PCK) were reported using a threshold of 15 cm. Metrics after Procrustes-Alignment (PA) were also reported as well as the F1-Score to evaluate detection.

Comparisons with Other Methods:

To compare example 3D recovery methods against other approaches, experiments used two settings with a ViT-L backbone: image resolution of 896×896, which yields optimal performances, and of 448×448 for SMPL benchmarks, denoted Multi-HMR-448, as it offers a good speed-performance trade-off and is more comparable to some existing methods which use 512×512 images.

### Body Mesh Recovery:

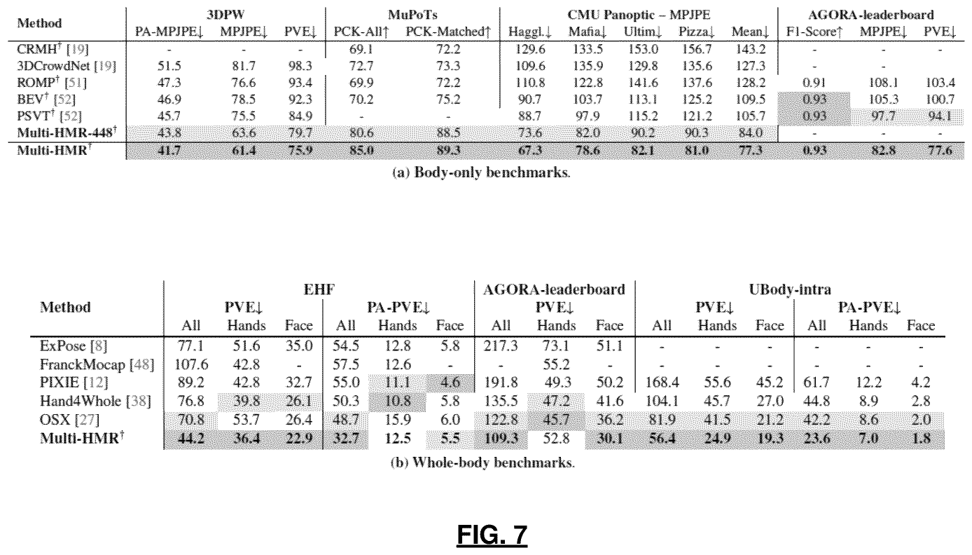

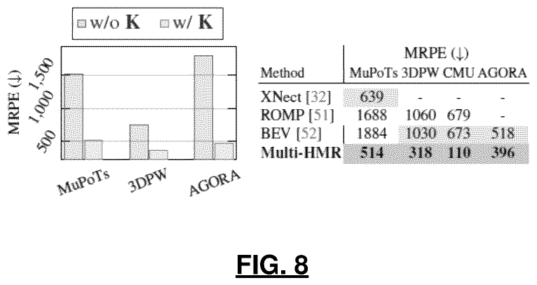

Example methods were compared against multi-person methods such as ROMP, BEV, and PSVT, in FIG. 7, top. The example Multi-HMR methods produced whole-body outputs, with predictions for faces and hands, while achieving high performance on all body-only benchmarks. Quantitative performance was improved by a significant margin.

### Whole-Body Mesh Recovery:

Since no previous multi-person whole-body human mesh approaches exist, example 3D recovery methods were compared in experiments against single-person whole-body 3D pose methods. These approaches do not consider the detection stage and the 3D positions in the scene, and assume predefined 2D bounding boxes around the person of interest. Results are shown in FIG. 7, bottom. While being able to detect multiple persons in a single shot, the example Multi-HMR method outperformed previous methods on whole-body human mesh benchmarks on most metrics, especially when considering the entire mesh. Multi-HMR obtained competitive performance on hands and faces, with reconstruction errors on par with or better than OSX, and it performed best for the whole mesh and the face on AGORA.

### Depth Estimation:

FIG. 8, right, shows a performance comparison in distance estimation to the state of the art, as disclosed in Mehta et al., Xnect: Real-time multi-person 3d motion capture with a single rgb camera, ACM Trans. Graph., 2020; Sun et al., Monocular, one-stage, regression of multiple 3d people, In ICCV, 2021; Sun et al., Putting people in their place: Monocular regression of 3d people in depth, In CVPR, 2022. Oher works assumed a fixed camera setting. For example, BEV is competitive on AGORA-val but does not generalize as well to datasets with different cameras. Since Multi-HMR is camera-aware, it gives accurate distance predictions across datasets and camera parameters (focal, principal point).

### Ablation Experiments

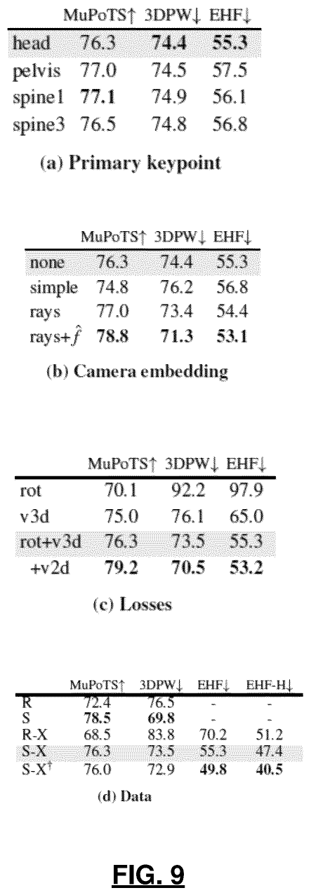

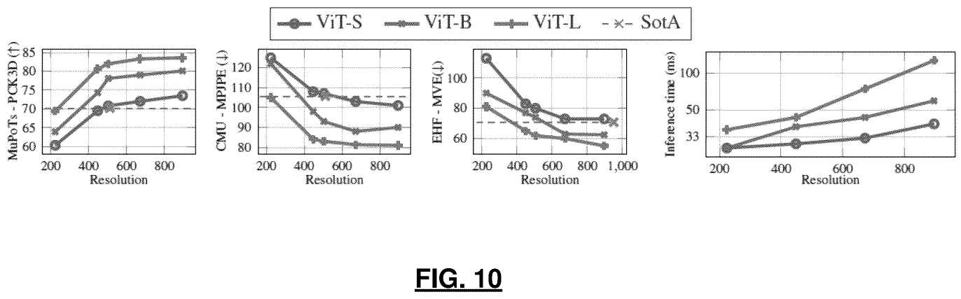

Primary keypoint: FIG. 9(a) shows results with different choices of primary keypoint: head, pelvis, or spine. Example Multi-HMR methods appear robust to this choice, though using the head as primary keypoint yielded best results by a small margin. Additional experiments kept the head as primary keypoint, also because it is the most often visible.

### Camera Embedding:

Experiments demonstrated that integrating camera information can improve accuracy when recovering and placing human 3D meshes in the scene. FIG. 9 (b) shows results with different kinds of camera embeddings; computing simple embedding (the normalized camera intrinsics are directly embedded into each patch) degraded performances compared to not adding camera embedding (i.e. none), while adding ray directions for each patch (denoted by rays) brought a gain.

When combined with focal length normalization f (normalizing the depth by a certain focal length), a clear gain in prediction accuracy was observed on all metrics. FIG. 8, left, further illustrates that conditioning the model on camera intrinsics can also improve depth prediction accuracy.

### Losses:

Experiments considered different combinations of reconstruction losses: directly on the SMPL-X parameters (rot), on the vertices produced by the SMPL-X model (v3d), a combination of both (rot+v3d), and the addition of reprojection losses (+v2d). FIG. 9(c) shows that adding as much supervision as possible (in 3D, 2D and rotation space) yielded the best performance, possibly because it reduced ambiguities during training.

### Data:

FIG. 9 (d) shows results of experiments with Real-world datasets (MS-COCO (Lin et al., Microsoft coco: Common objects in context. In ECCV, 2014), MPII (Andriluka et al., 2D human pose estimation: New benchmark and state of the art analysis, In CVPR, 2014), and H3.6M (lonescu et al., Human3.6M: Large scale datasets and predictive methods for 3D human sensing in natural environments, IEEE trans. PAMI, 2013), for which pseudo-ground-truth fits are obtained by minimizing the reprojection error of annotated keypoints and with Synthetic datasets, namely BEDLAM and AGORA as well as a synthetic dataset generated using example methods herein (t). In both cases experiments were conducted with the SMPL and SMPL-X body models.

Multi-HMR matched other methods with real images using images with pseudo-ground-truth (Moon et al., Neuralannot: Neural annotator for 3d human mesh training sets, In CVPR Worskhop, 2022; Moon et al., Three recipes for better 3d pseudogts of 3d human mesh estimation in the wild; In CVPR Workshop, 2023.) on both body-only and whole-body benchmarks, though performance did degrade when using SMPL-X, which may be due to the lack of accuracy for small body parts (hands, faces) in the fits used as ground-truth for training. Performance improved substantially when using synthetic data, demonstrating that perfect 3D annotations are useful for accurate and robust predictions, in particular when considering faces and hands. It has previously been disclosed (Black et al., BEDLAM: A synthetic dataset of bodies exhibiting detailed lifelike animated motion, In CVPR, 2023) that training with large-scale synthetic data only is better than training with pseudo-fits acquired by minimizing reprojection of 2D keypoints on real images.

Experiments also evaluated the example synthetic booster dataset, containing people close to the camera and with diverse hand poses. Since current synthetic datasets such as BEDLAM and AGORA do not consider people close to the camera, images were generated following this particular setting. Adding this data to the training set significantly improved performance on whole-body mesh recovery, due to improved predictions on expressive body parts (hands and faces).

### Input Resolution and Backbone:

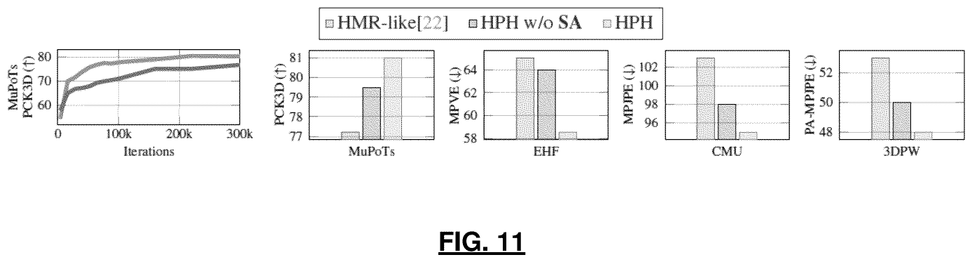

Additional experiments empirically evaluated the impact of the input image resolution on the final performance, for different backbone sizes (ViT-S, ViT-B, ViT-L), as shown in FIG. 10. Increasing the input resolution consistently provided performance gains across backbone sizes, though at the cost of increased inference time (right). A ViT-L backbone at 448×448 inputs arguably offers a good performance versus speed trade-off for body-only metrics, while using higher resolutions can be more worthwhile for whole-body metrics.

Further experiments were conducted with different pre-training methods, in which DinoV2 outperformed the others. The largest backbone (ViT-L) at a 896×896 resolution took approximately 120 ms to forward propagate—without compressing or quantizing the network—which is fast compared to multi-stage methods. For applications requiring real-time inference (30 FPS), a ViT-S combined with an image resolution of 672 provided optimal performance and already matched or surpassed the state of the art.

### Head.

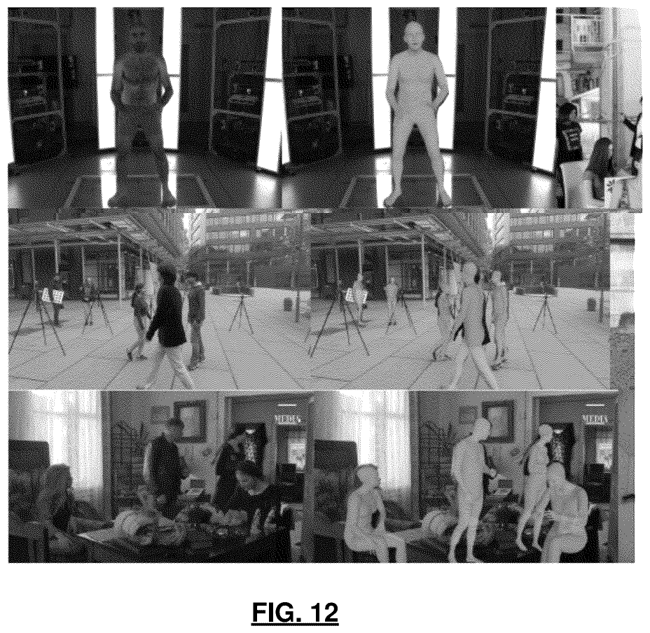

FIG. 11 shows a comparison of different perception heads to regress the SMPL-X parameters. The baseline ‘HMR-like’ uses a vanilla iterative regressor (Kolotouros et al., Learning to reconstruct 3d human pose and shape via model-fitting in the loop, In ICCV, 2019, which is incorporated herein in its entirety) applied to each detected feature token independently. ‘HPH’ converged faster (left) and performed better (right). ‘HPH w/o SA’ denotes a variant where queries are treated independently by removing SA blocks from the HPH (e.g., Equation (5)). It was demonstrated that treating queries together was beneficial (FIG. 11, right).

### Synthetic Dataset Generation

Existing synthetic datasets, such as BEDLAM and AGORA, can provide perfect ground truths for the SMPL-X model, including faces and hands. However, in these datasets, most humans are seen from afar, which is not ideal to capture subtle details needed to properly reconstruct faces and hands. Further, the hand poses lack diversity. As example 3D recovery methods are single-shot, i.e., run without specific image crops or feature resampling around hands, hands consist of only a few visible pixels for many training images. As disclosed above, example training methods can be further improved by supplementing the training data with a dedicated, booster dataset, which includes close-up pictures of single humans with clearly visible hands (or other expressive body parts) in diverse poses.

### 3D Human Models:

An example method for generating a synthetic dataset renders images of 3D human models. Following the strategy of BEDLAM (Black et al., BEDLAM: A synthetic dataset of bodies exhibiting detailed lifelike animated motion, In CVPR, 2023), a procedural generation pipeline may be used with fine control over parameters, rather than commercially available scans of clothed humans (e.g., as in AGORA). Example methods employ a human generator such as HumGen3D (https://www.humgen3d.com), which is an open-source human generator add-on to the Blender software tool. Such an add-on can generate 3D rigged human models, with different clothing (layered on top of the body mesh), hairstyles, skin tones, age, etc. This yields a high diversity of humans overall.

Retargeting with SMPL-X:

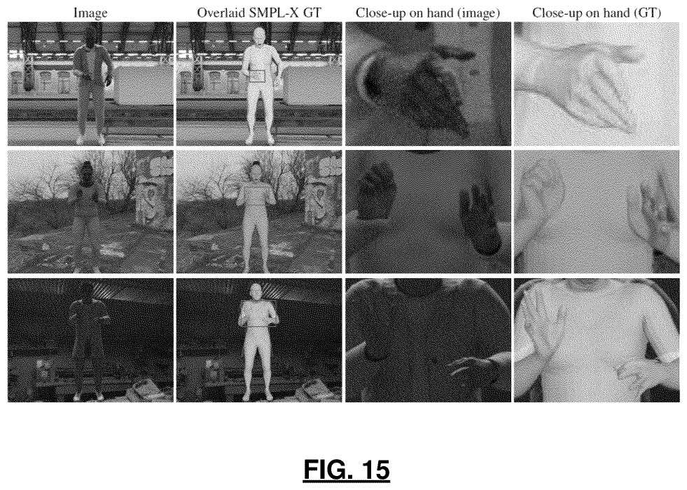

To provide precisely annotated images, an example method manually defines pointwise correspondences between the SMPL-X and the HumGen3D meshes. For a given set of SMPL-X parameters as input, an example method iteratively optimizes the skeleton parameters of the HumGen3D model, which control the corresponding mesh through linear blend skinning, to minimize the distance between keypoints of both meshes. FIG. 14 shows examples of rendered avatars and their associated SMPL-X meshes and allows verifying of the quality of the retargeting.

### Rendering:

Characters may be placed into empty scenes so as to take up, for instance, a majority or most of the space in the camera plane with random HDRIs images taken, for instance, from Poly Haven (https://polyhaven.com/) as environment maps. An example method uses a focal of 843 pixels and renders images with resolution 900×675. The principal point is set at the center of the image.

### Human Shape Sources and Hand Diversity:

A goal of example synthetic dataset generation methods is to generate humans that are: i) close to the camera such that the hands are sufficiently visible, and ii) with diverse hand poses. For the first point i), an example method renders images of a single person, facing the camera, at a distance varying slightly around 2.5 meters, which was found to yield visible hands.

For the second point ii), human poses are sampled from BEDLAM, AGORA, and UBody, where hand annotations are respectively: taken from the GRAB dataset (Taheri et al., GRAB: A dataset of whole-body human grasping of objects, In ECCV, 2020), fitted to 3D scans, and fitted to in-the-wild images. In addition to these three example sources, in order to further diversify the generated set of hand poses, UBody's annotations are further augmented with hands from other sources. For example, a large set of diverse hand poses are created using MANO annotations from the InterHand dataset (Moon et al., Interhand2. 6m: A dataset and baseline for 3d interacting hand pose estimation from a single rgb image, In ECCV, 2020). This can be done by extracting all MANO annotations and transforming hands into right-hand format. When creating a synthetic image with augmented hands, an example method samples two random hands from the large set, transforms one into a left hand, and replaces hands from the chosen SMPL-X annotations using the new hand poses. This can provide an even richer set of hands than the original InterHand annotations, in that left hands can be turned into right hands, which increases the number of possible combinations.

### Dataset:

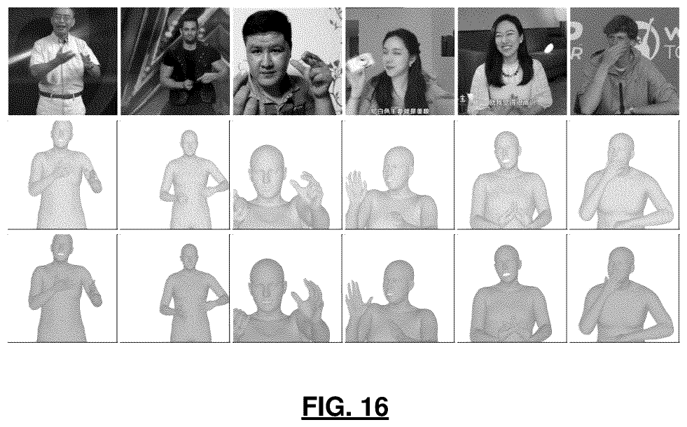

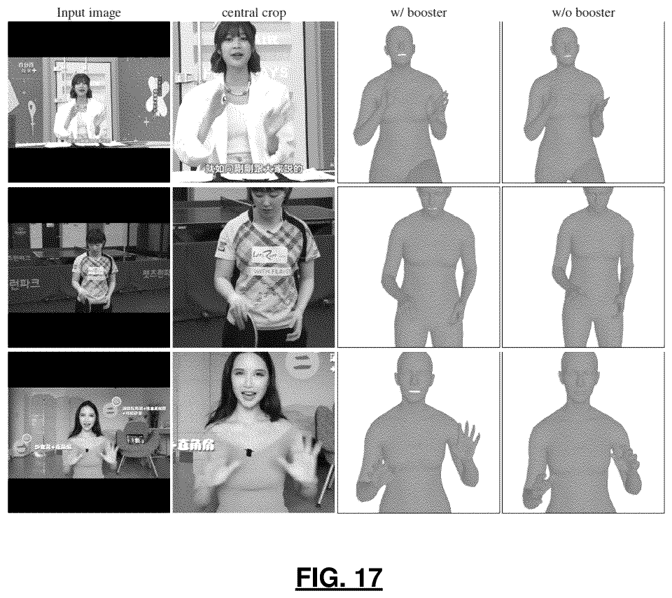

An example method generates about 73k images, equally spread with human shapes from i) BEDLAM, ii) AGORA, iii) UBody, iv) UBody with increased hand diversity. FIGS. 14-15 show qualitative examples of generated images and the associated SMPL-X mesh. FIG. 16 shows examples of hand swapped shapes. FIG. 15 shows examples from a synthetic booster dataset showing the input image, the overlaid SMPL-X annotations, the close-up image, and annotations around the hands corresponding to the rectangle shown in the second column. People are seen up close, and diverse hand poses are used. FIG. 16 illustrates increasing hand diversity in human shape sources to be rendered. Given an annotation from UBody (image on top, annotation in the middle row), an example method swaps the hands from a large set built from InterHand to have more diversity in terms of hand poses.

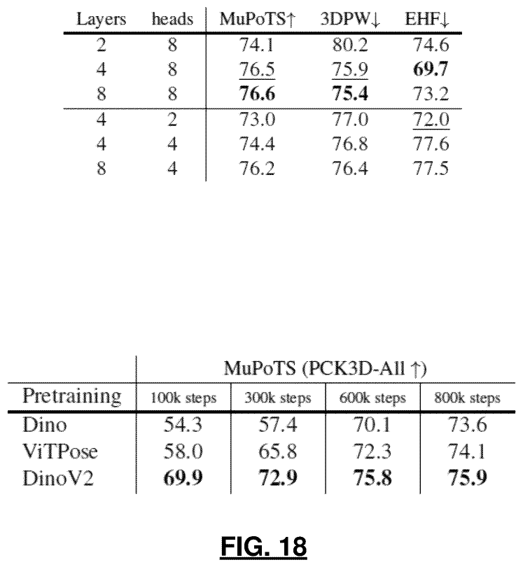

Adding example synthetic datasets can provide both qualitative and quantitative benefits. For example, as shown in FIG. 17, the hands are significantly better predicted when the training set includes the synthetic booster dataset.

### Additional Ablation Experiments

Additional ablation experiments were conducted regarding i) ablations on the architecture of the example Human Perception Head (HPH) module, ii) ablations on the type of pretraining used to initialize the backbone for Multi-HMR, and finally iii) results on all benchmarks obtained with a universal model, without any dataset-specific finetuning.

### Ablation HPH:

FIG. 18 (top) shows results of experiments with different configurations for the HPH module, using a ViT-Base architecture as backbone and images of resolution 448×448 as input. Results were reported after 500 training steps. As the HPH module is based on cross-attention layers, the main parameters are the number of layers and the number of heads used. It was observed that increasing the number of layers and the number of heads leads to performance improvements, though at the cost of increased training and inference times (with a diminishing return). Accordingly, further experiments kept a simple setting as default, with 2 layers and 8 attention heads.

### Backbone:

FIG. 18 (bottom) shows results using various pretraining methods, with a ViT-Base architecture and 448×448 input images. Dino (Caron et al., Emerging properties in self-supervised vision transformers, In ICCV, 2021) and DinoV2 (Oquab et al., Dinov2: Learning robust visual features without supervision, arXiv preprint arXiv:2304.07193, 2023, each of which is incorporated herein in its entirety) rely on self-supervised pre-training, while ViTPose is trained with 2D body keypoints supervision. It was observed that DinoV2 led to the best final performance, and converged faster. The difference in performance decreased with time, which may be due to the relatively large size of the example training set, with ViTPose eventually achieving comparable results. Using DinoV2 may be most beneficial when training computation is limited.

### Universal Model:

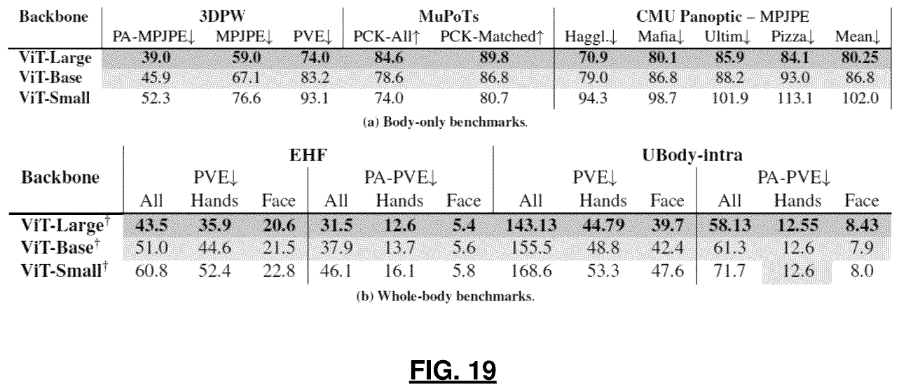

FIG. 19 shows additional experimental results obtained with a single checkpoint shared for all benchmarks, without finetuning on any specific dataset. Results are reported at input resolution 896×896, for ViT-Small, ViT-Base and ViT-Large backbones, and models were trained simultaneously on AGORA, BEDLAM, 3DPW and an example synthetic booster dataset. Results demonstrated that finetuning was useful to achieve optimal performance on this dataset with Multi-HMR and large backbones. Including 3DPW in the training from the start improved results further compared to simple finetuning. Further, it was demonstrated that performance on MuPoTS, CMU and EHF was maintained or improved. For all benchmarks except Ubody, example universal Multi-HMR models could achieve state-of-the-art performance with a single checkpoint, even without fine-tuning.

### Results on BEDLAM-Test:

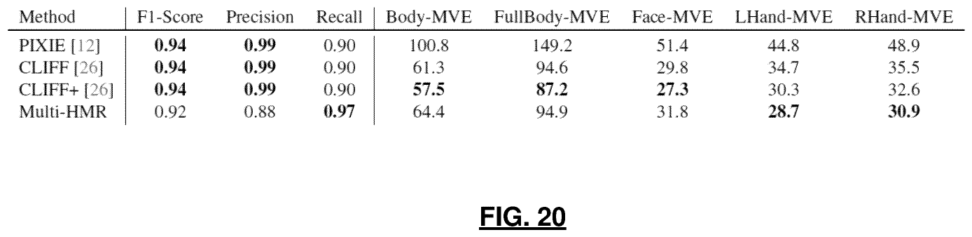

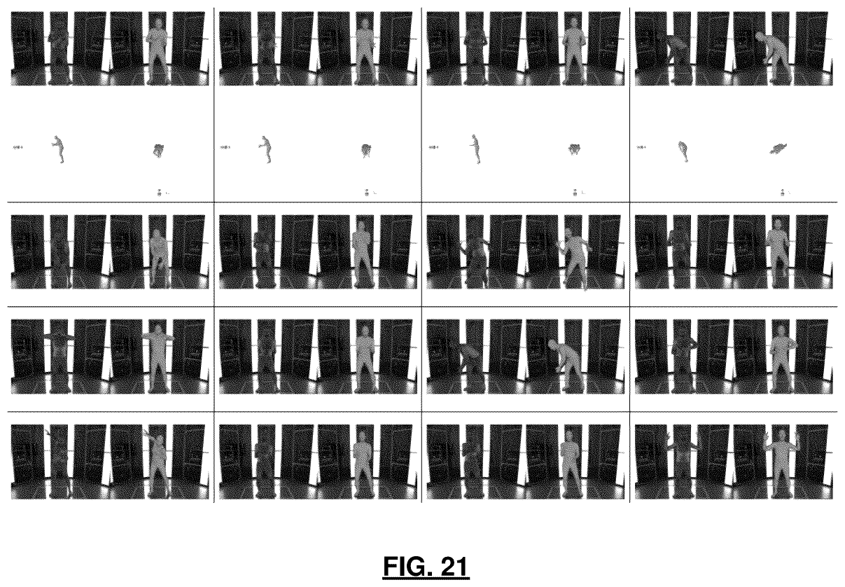

FIG. 20 shows results on the BEDLAM-test dataset using an online leaderboard, demonstrating that example Multi-HMR methods described herein achieve competitive performances on this dataset.

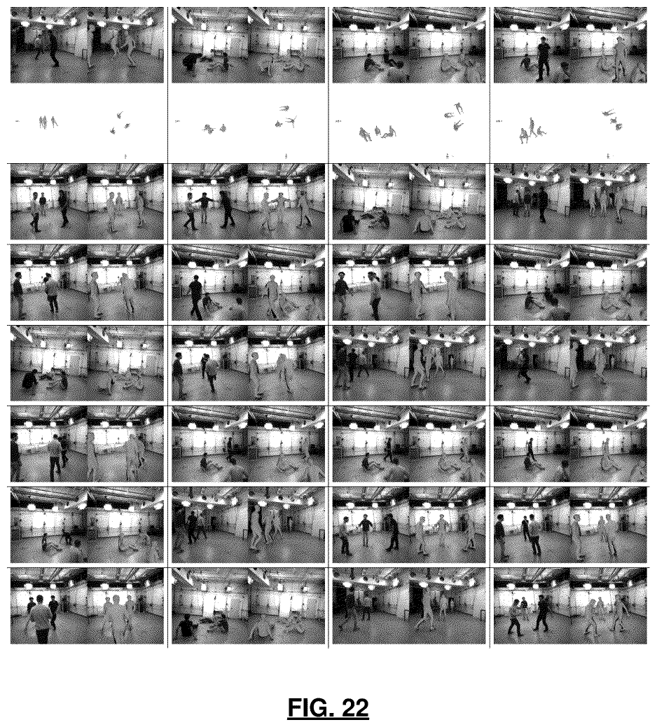

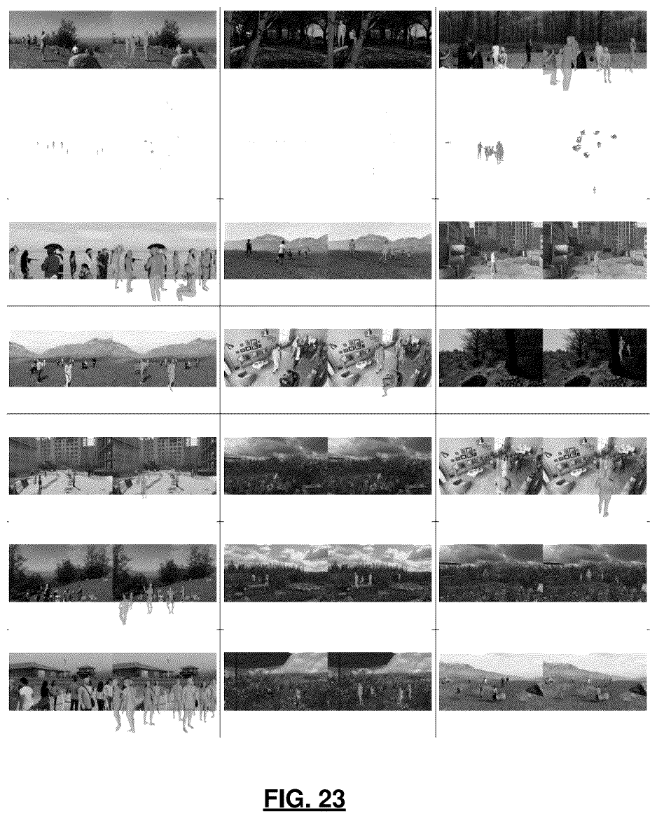

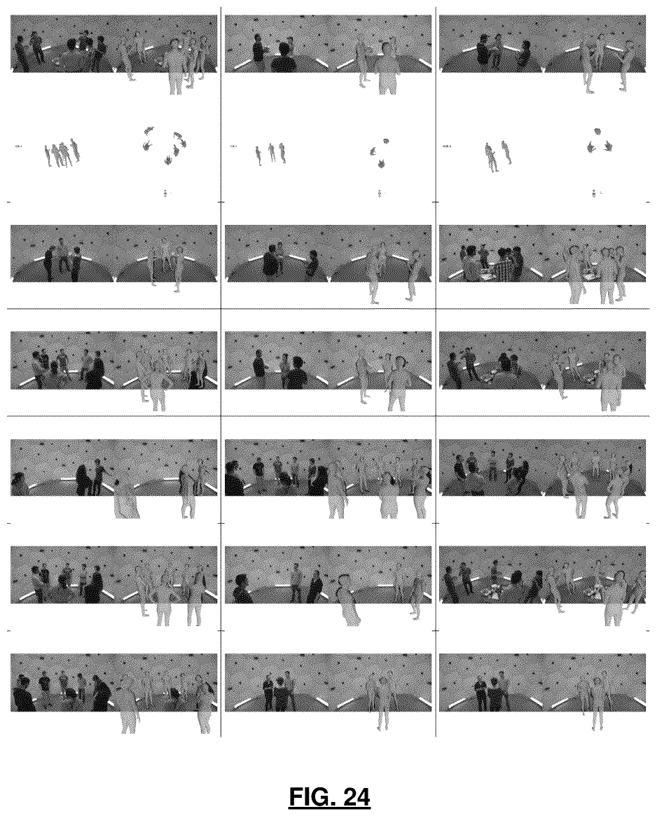

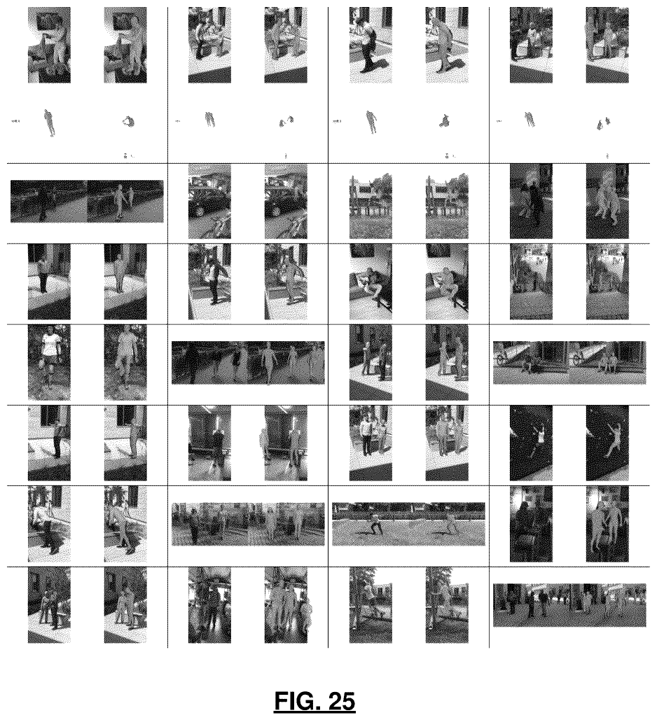

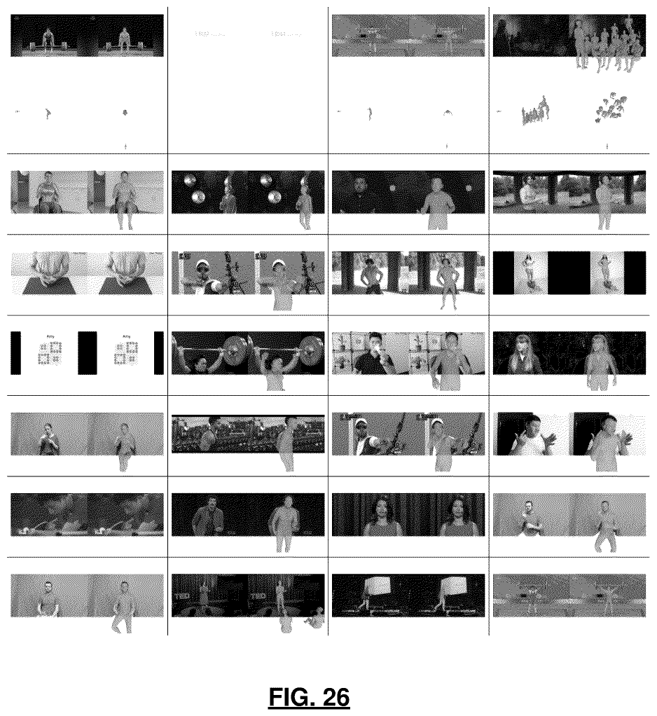

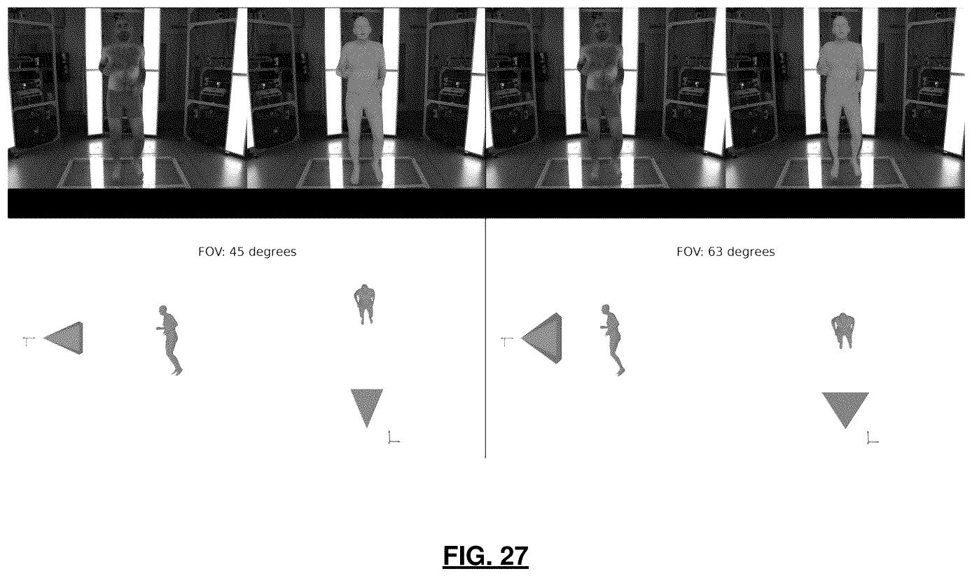

Visualization on validation/test images: Randomly selected images are provided from the various test and validation datasets used in example experiments, namely EHF (FIG. 21), MuPoTS (FIG. 22), AGORA (FIG. 23, CMU panoptics (FIG. 24), 3DPW (FIG. 25), and UBody (FIG. 26). The figures were generated after randomly shuffling the datasets. Together, these datasets offer a large variety in terms of poses, backgrounds, viewpoints, ethnicity, group size and density, distance to the camera, and expressivity of the hands and faces. Qualitatively, the predictions displayed (both reprojections in the image plane as well as Bird-eye views) show that example Multi-HMR methods described herein provided overall accurate predictions across all settings.

### Impact of Focal Length:

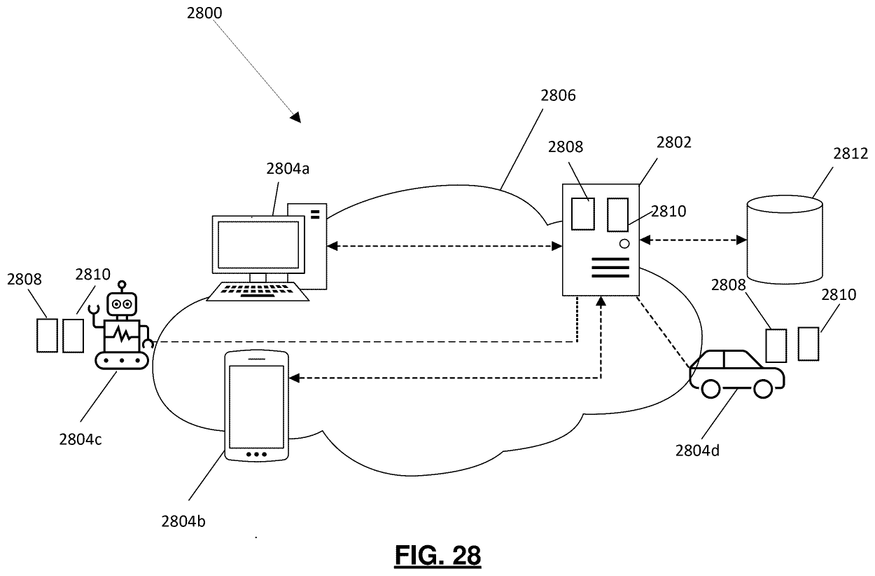

The impact of the input camera parameters for an example Multi-HMR model was investigated by varying the focal length given as input. To do so experiments kept the same image but artificially changed the value of the focal length given as input to Multi-HMR and visualized the reconstructed mesh, as illustrated in FIG. 27. It was observed that the example Multi-HMR model described herein adapted the shape and the distance of humans in the 3D scene such that the re-projection in the image plane remains consistent. This validates the use of the camera parameters by the example Multi-HMR model.

### Robustness to Occlusion:

Further experiments produced synthetic occlusion by adding a grey square in the input image and visualize the 3D reconstruction done by Multi-HMR. Example models consistently produced plausible predictions and the overall 3D reconstruction still remained of very good quality. For instance, by pausing video when grey squares covered the hands one can observe that the model predicts wrong but coherent hand pauses when the hands are occluded.

### Applications

Example 3D recovery models such as Multi-HMR models have various applications. For instance, in virtual or augmented reality (VR/AR) or so-called spatial computing applications, capturing features such as faces and hands more precisely is highly useful, as it is a significant component of common human communication. Capturing such features is also beneficial for further enabling interaction between humans and autonomous devices such as robots. It can also be beneficial for human understanding from media such as images or videos. Likewise, understanding the placement of people in a scene is useful for applications ranging from robotic navigation to VR/AR/spatial computing applications involving multiple people. Efficient processing of a variable number of people is desirable when computation capacity is restricted and/or when real-time processing is needed. Further, adaptability to camera information, when known, can improve reasoning about 3D meshes. In some specific applications, such 3D recovery models may be used for enabling (i) robot navigation in confined and crowded spaces such as elevators, and (ii) data annotation or animation as part of a workflow that first identifies people within a scene and then allows for the annotation of or animation using recovered 3D meshes.

### Network and Hardware Architecture

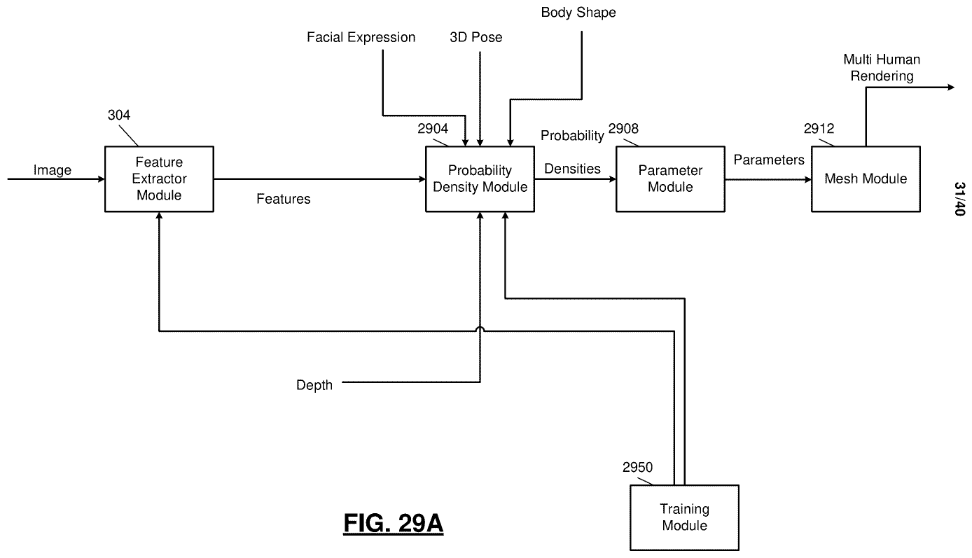

Example systems, methods, and embodiments may be implemented within an architecture/system 2800 or a portion thereof such as illustrated in FIG. 28. The architecture 2800 may include a server 2802 and/or may include one or more devices such as devices 2804. The devices 2804 may operate as client devices and may communicate over a network 2806 which may be wireless and/or wired, such as the Internet, for data exchange, or may operate as standalone devices (or even disconnected from the server 2802 entirely).

The server 2802 and the devices 2804 can each include a processor, e.g., processor 2808, and a memory, e.g., memory, such as but not limited to random-access memory (RAM), read-only memory (ROM), hard disks, solid state disks, or other nonvolatile storage media. Memory 2810 may also be provided in whole or in part by external storage in communication with the processor 2808.

The architecture 100 or 300, for instance, may be provided in the server 2802 and/or one or more of the devices 2804. In some example embodiments, the architecture 100, 300 is provided in the devices 2804, possibly without the training module 130, and/or the training module 130 is provided in the devices 2804 and/or the server 2802. In other example embodiments, the server 2802 trains the architecture 100, 300 or pretrains the architecture offline, and the architecture is then provided in the devices, or the architecture may be integrated into an architecture in the devices and end-to-end trained.

It will be appreciated that the processor 2808 in the server 2802 or any of the devices 2804 can include either a single processor or multiple processors operating in series or in parallel, and that the memory 2810 in the server 2802 or any of the devices 2804 can include one or more memories, including combinations of memory types and/or locations. Server 2802 may also include, but are not limited to, dedicated servers, cloud-based servers, or a combination (e.g., shared). Storage, e.g., a database, may be embodied in suitable storage in the server 2802, device 2804, a connected remote storage 2812 (shown in connection with the server 2802, but can likewise be connected to client devices), or any combination.

Devices 2804 may be any processor-based computing device, terminal, etc., and/or may be embodied in an application executable by a processor-based device, etc. Example devices include, but are not limited to, autonomous devices, media or display devices, interactive devices, smartphones, tablet computers, etc. Devices 2804 may operate as clients (computing devices) and be disposed within the server 2802 and/or external to the server (local or remote, or any combination) and in communication with the server, or may operate as standalone devices, or a combination.

Example devices 2804 include, but are not limited to, autonomous computers 2804a, mobile communication devices (e.g., smartphones, tablet computers, etc.) 2804b, robots 2804c, autonomous vehicles 2804d, wearable devices, virtual reality, augmented reality, or mixed reality devices (not shown), or others. Devices 2804 communicating with the server 2802 may be configured for sending data to and/or receiving data from the server, while other devices 2804 may be standalone devices. Devices may include, but need not include, one or more input devices, such as image capturing devices, and/or output devices, such as for communicating, e.g., transmitting, actions determined through navigation methods. Devices may include combinations of client devices.

In example training methods, the server 2802 or devices 2804 may receive a dataset from any suitable source, e.g., from a memory 2810 (as nonlimiting examples, internal storage, an internal database, etc.), from external (e.g., remote) storage 2812 connected locally or over the network 2806. For 3D mesh recovery training, devices 2804 may receive datasets including images, possibly including synthetic datasets, which may but need not include synthetic booster datasets as provided herein. The example training methods can generate a trained model or portion thereof that can be likewise stored in the server (e.g., memory 2810), devices 2804, external storage 2812, or combination. In some example embodiments provided herein, training may be performed offline or online (e.g., at run time), in any combination.

The example architecture 100 shown in FIG. 1 or portions thereof may be incorporated into a device such as an autonomous apparatus (e.g., vehicle 2804d or robot 2804c), interactive device, AR/VR device, etc. The architecture 100 may include an image-capturing device such as a camera 102 having camera intrinsics. The camera 102 can generate a (for example) 2D image of a scene for input into the example 3D mesh recovery model.

An example device, such as but not limited to an autonomous device, alone or via communication with another device 2804 or server 2802, may train, e.g., using training module 130, an architecture 100 embodied in a machine learning model for a downstream task. Alternatively, the device may receive from the server 2802 a trained architecture trained by the server, e.g., using training module 130 (or similar model for architecture 100) or by another device. Models may be updated or fine-tuned. Updated models including parameters may be stored in memory 2810.

The device may apply the trained machine learning model to receive one or more images obtained from the camera 102 as needed to generate whole-body multi-human 3D meshes. The device may then adapt its display, e.g., display 124, or other interface, and/or adapt its motion state (e.g., velocity or direction of motion) or other actuating operation based on the generated 3D meshes. For example, the controller 126 may be configured to control operation of the actuator 128, e.g., a propulsion device, to navigate the autonomous apparatus to perform a downstream task.

As discussed above, the task of multi-person human mesh recovery includes detecting all individuals in a given input image, and in predicting the body shape, body pose, and 3D location for each detected person. An approach to solving this task is provided above and involves training neural networks in a deterministic manner, resulting in a single prediction for each detected individual.

The present application involves a probabilistic method that outputs parametric distributions over likely poses, body shapes, intrinsics and distances to the camera, using a probabilistic network, such as a Bayesian network.

This has multiple advantages over the deterministic approach. For example, a probability distribution can handle ambiguities inherent to the task of multi person human mesh recovery, such as ambiguities between the size of a person and its distance to the camera, or simply due to the loss of information when projecting 3D onto the image plane. As another example, the output distributions can be combined with external input priors to produce better predictions. This enables several applications such as merging multi-view predictions or injecting privileged information such as with depth or body shape. The present application involves training the model with synthetic data generated to include a strong diversity in poses, body shapes, number of people, and view points.

The model architected and trained as described herein i) achieves high performance ii) is able to capture uncertainties and correlations inherent to pose estimation, and iii) can exploit privileged information at test time, such as multi-view consistency or body shape priors. Substantial performance improvements are achieved on multi-view benchmarks.

Recovering people characteristics in 3D from images enables performance of various tasks and applications, such as human behavior studies and robotic actuation in crowded environments. The present application involves first detecting people visible in images and then predict a 3D mesh encoding their individual poses, locations and body shapes in 3D.

Multiple meshes can be plausible for a person in an input image, such as due to clothing, partial occlusions, or other ambiguities caused by the projective nature of 2D imaging. The 2D apparent size of a person in an image depends on actual 3D size, 3D distance to the camera, as well as the camera focal length. Deterministic approaches predict average attributes weighted by their frequency of occurrence in the training data.

The probabilistic framework described herein manages this uncertainty. The present application involves decomposing the mesh recovery task into a task of recovering various attributes (pose, body shape, location, etc.), and modelling the joint probability distribution over these attributes. For example, a parametric Bayesian model may be used which, given an input image, outputs a distribution over camera intrinsics, human detections, their poses, body shapes and 3D locations.

This formulation can account for several sources of ambiguity inherent to the multiple human mesh recover task. The Bayesian framework allows for efficiently exploitation of privileged information about body shapes, distances or camera at inference, for instance using the ground truth. In addition, the described systems and methods offer an elegant way to merge multiple predictions from different input images: multiple output parametric distributions for multiple images can be combined into a single one and meshes extracted from it. This enables training of the model described herein on monocular data but make multi-view predictions at test time and inference time.

In various implementations, the model may be trained (by a training module) using only synthetic data, such as using data from the BEDLAM dataset and synthetic images generated to further increase data variability. The Bayesian nature of the model offers flexibility for various applications using privileged information. For example, predetermined ground-truth parameters (e.g., camera intrinsics or body shape) can be input the model to improve predictions in a zero shot manner. This can also be used to maintain coherence between multiple input images, such as a constant body shape for a given person.

As stated above, the present application involves Bayesian network model for multi-person whole-body human mesh recovery. The model outputs parametric distributions, it can account for ambiguities inherent to the task, be conditioned on privileged information, and fuse output distributions for multiple inputs.

In the present application, the prediction head may be conditional. This allows the use of prior knowledge, when available, as well as to merge outputs from multiple views in a simple and elegant way.

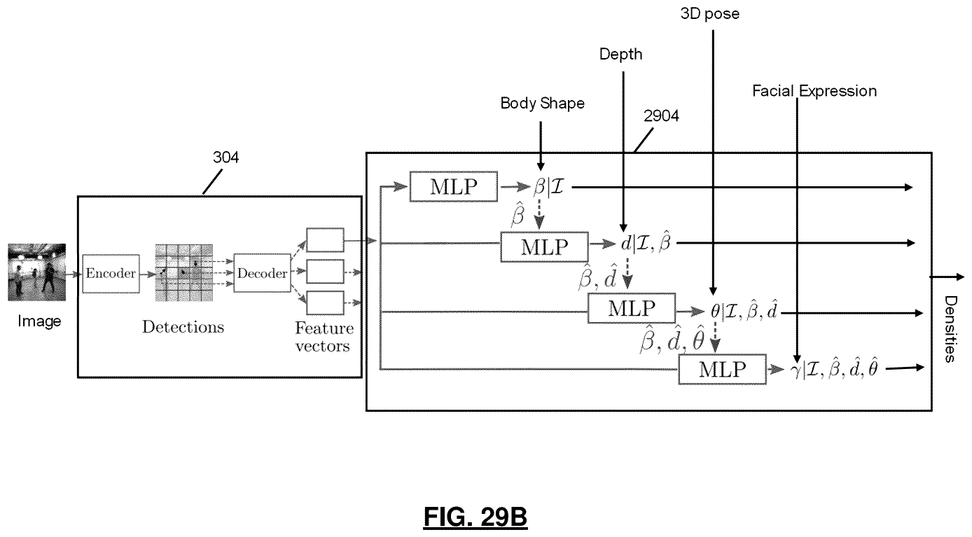

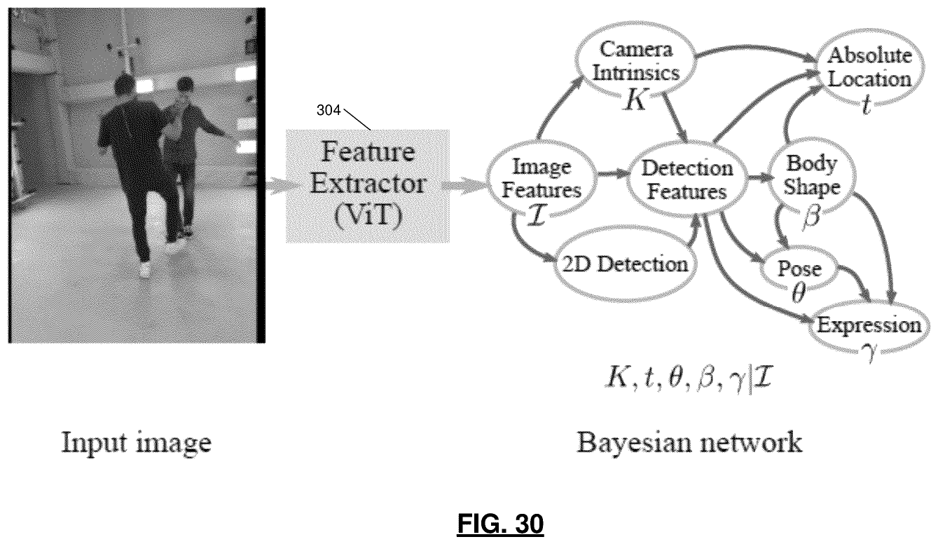

As illustrated in FIG. 29A, the feature extractor module 304 extracts image features from an input image as discussed above. The detections are performed as described above. In the present application, a probability density module 2904 determines probability densities for sets, respectively, of (a) camera parameters 8, (b) locations t, (c) body shapes β, (d) poses θ, and (e) expressions γ based on the image features I. This may be said to be determining the parameters jointly. The probability density module 2904 may determine the probability densities, for example, using a Bayesian network or another suitable type of probabilistic model using the image features. The probability density module 2904 and the parameter module 2908 may be implemented in a decoder module as discussed above.

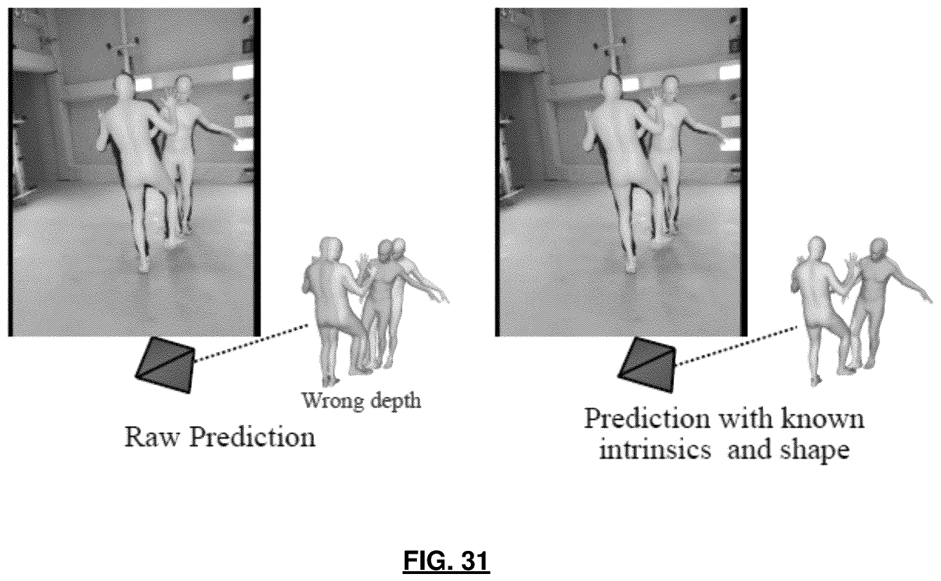

A parameter module 2908 selects the set with the highest probability. The parameters of the selected set can be used to generate the meshes of the multiple humans in the input image. A mesh module 2912 generates the meshes of the humans in the input image based on the selected set. The mesh module 2912 and the 3D parametric model may be included in the mesh positioning module as described above. FIG. 30 includes a block diagram illustrating an example of concepts of FIGS. 29A and 29B.

The feature extractor module 304 extracts image features in the input image, such as using a Vision Transformer (ViT) backbone, as discussed above. The image features are used as conditioning variables of a joint probability distribution for modeling people appearing in the input image with different attributes (3D location, body shape, etc.). The joint distribution may be determined using a trained Bayesian network (e.g., of the. At inference, the human in an image can be detected and their attributes predicted by extracting modes of the conditional probability distributions in cascade. The probabilistic framework enables the exploitation of different priors available at inference, for example when the camera intrinsic parameters or the body shape of the persons are known/predetermined.

To encode the parameters of the selected set into human meshes, a parametric body model is used, such as the SMPL-X parametric body model or another suitable parametric body model. The parametric body model provides a whole-body parametrization decoupled into an absolute 3D location t, a list of bone orientations θ modeling the pose, a vector β modeling the body shape, and a vector γ modeling the facial expression.

The multi-person mesh recovery problem herein is modeled as a probabilistic optimization problem. Given input image features I, the present application involves determining/predicting the values of different random variables: the intrinsic parameters K of the camera, and attributes of the humans visible in the image (t, θ, β, γ).

The probability density module 2904 determines the joint probability distribution of these variables conditioned on the image features, and the parameter module 2908 extracts the most likely prediction:

$$\hat{K} , \hat{t} , \hat{θ} , \hat{β} , \hat{γ} = arg max p ( K , t , θ , β , γ \vert I ) , \qquad ( 9 )$$

where p(K, t, θ, β, γ|I) denotes the associated probability density. The representation space for the meshes may have high dimensionality, such as dim(K)=3, dim(t)=3, dim(p)=11, dim(d)=1, dim(θ)=53×3, dim(γ)=10 in our setting. The present application however is also applicable to other dimensionality.

In various implementations, a naive Bayes network may be used which may determine the attributes independently based on the image features, such as described by:

$$p ( β , d , θ \vert I ) = p ( β \vert I ) \cdot p ( d \vert I , β ) \cdot p ( θ \vert I , β , d ) \cdot p ( γ \vert I , β , d , θ ) )$$

where p(x|y) denotes probability density at x conditioned on the value y. The density function p(⋅|y) may belong to a parametric family, with parameters a function of the input y, e.g., regressed using a neural network.

A limitation of the conditional independence assumption made by a naive Bayes network may be that it prevents modeling inter-relations between variables. The inter-relations however may be significant. For example, a small person A appearing the same size in 2D as a taller person B is likely to be closer to the camera than B, other things being equal.

To overcome these challenges, the probability density module 2904 may model the joint distribution using a Bayesian network, decoupling the variables into a directed acyclic graph of conditional distributions, such as illustrated in FIG. 30. The probability density module 2904 can auto-regressively model complex the high-dimensional data for the generation of the human meshes.

The probability density module 2904 models a full parametric distribution over each variable (attribute). Relationships between variables may be in a cascaded manner. FIG. 29B shows an example architecture cascading the MLPs in FIG. 4C. An image is encoded and then decoded using a transformer-based architecture to produce one feature vector per detected person using the method disclosed herein. From each feature vector (I), conditional probability distributions for the different human attributes are estimated in cascade using conditional prediction heads. Regarding the cascading, first a shape distribution may be predicted (β), then the distance from the camera (d) conditioned on the predicted body shape, then the 3D pose (θ) conditioned on the selected body shape and selected distance from the camera, and finally the facial expression (γ) conditioned on the selected body shape, selected distance from the camera and selected 3D pose (e.g., p(β,d,θ|I)=p(β|I)·p(d|I,β)·(θ|I,β,d)·p(γ|I,β,d,θ)). Conditioning quantities can be given as external inputs, extracted as modes of the predicted distributions, sampled, or optimized (e.g., through gradient ascent), in order to exploit the various priors available at inference.

The probability density module 2904 is trained to predict conditional distributions belonging to a parametric family (e.g., normal distributions), whose parameters (mean p and variance Σ in this case) are regressed using a multi-layer perceptron (MLP) from the values taken by the conditioning variables.

For the camera intrinsics, a pinhole model may be used, for which camera intrinsics can be parameterized by a focal length f>0, and 2D coordinates of the principal point p∈R₂ of the camera. We model the conditional distributions of ln(f) (e.g., to ensure positivity) and p as normal distributions, whose parameters are regressed from image features, such as the [CLS] token output by the feature extractor module 304.

The image features produced by the feature extractor module 304 include patch tokens P_{u,v} defined along a 2D regular grid G={(u,v)}_{u=1, v=1 . . . h}. The feature extractor module 304 may encode human detections as binary variables s_{u,v} along this grid, modeling if a reference keypoint of a person projects into a grid cell (u,v)∈G.

The probability density module 2904 determines for each variable a score encoding the detection likelihood p(s_{u,v}|I), that is regressed from the corresponding patch features P_{u,v}. As stated above, human heads may be used as reference keypoints, and it may be assumed that at most one person can be detected in each cell. At inference, detection is performed using the thresholding discussed above and local non-maxima suppression strategy.

For each detected person, the probability density module 2904 may consider a latent variable whose value includes image patch features extracted from the detection location and augmented with camera ray embeddings, such as described above. These detection features may be used as conditioning variable for regressing the different human attributes.

A parametric body model, such as SMPL-X, parameterizes body shape and expressions as latent vectors of a PCA space of dimension D (e.g., D=11 for shape, D=10 for expression). The conditional shape distribution may be modeled as a multivariate diagonal Gaussian distribution, and the conditional expression distribution may be modeled similarly.

Absolute 3D location of the person may be decomposed into 2D coordinates c of the reference keypoint in the image, and distance d to the image plane. Distance may be encoded as a variable ln(d/f) to ensure positivity and enforce a stronger conditioning on camera intrinsics, and conditional distributions c and ln(d/f) may be modeled as normal distributions.

Pose may be parameterized as a tuple θ∈SO(3)_{J} of J=53 bone orientations. SO(3) has a more complex topology than the PCA space of shapes and expressions, and we model conditional pose distribution as a product of independent matrix Fisher distributions Π_{Jj=1}F(Fⱼ), of density defined up to a normalizing constant c(F) by:

$${p}_{F ( F )} ( R ) = c ( F ) exp ( Tr ( {F}_{⊤} R ) ) . \qquad ( 10 )$$

### Distribution Parametrization.

To prevent regressing D-dimensional Gaussian distributions N(μ,σ), the probability density module 2904 may regress the mode μ∈R_{D} of the distribution along with some dispersion σ∈R_{D} parameters, from which the probability density module 2904 may determine a diagonal covariance matrix Σ=diag(1+exp(σ))₂. The probability density module 2904 may replace the matrix parameter F∈M_{3×3}( [symbol] ) of a matrix Fisher distribution F(F) by a mode R∈SO(3) and dispersion parameters (O∈SO(3), Λ∈R₃) that can be regressed by a MLP module, and combine, such as described by:

$$F = RO diag ( λ sigmoid ( Λ ) ) {O}_{⊤} ,$$

where sigmoid denotes the elementwise sigmoid function and A is a predetermined positive scaling constant. In various implementations, A may be 2 or another suitable value. Rotations are regressed by the probability density module 2904 as 3×3 matrices that are orthonormalized using a differentiable Procrustes operator.

The matrix Fisher probability density function of Eq. (10) is defined up to a normalizing constant c(F). Numerical integration may be used to evaluate it, such as by sampling a predetermined number of rotations on a uniform SO(3) grid.

In various implementations, one may be interested in extracting the most likely predictions given observations, which is the solution of Eq. (9). Finding an optimal solution may be difficult because of the non-linearities of MLPs regressing parameters of our conditional distributions. The present application may use a greedy approach including considering conditional distributions sequentially in a feed-forward manner, extracting modes of the conditional distributions considered, and using them as conditioning value for the downstream conditional distributions of the Bayesian graph. Since modes are available in the parametrization of the normal and Fisher distributions considered.

One advantage of modeling conditional distributions (probability densities) over deterministic regression is the ability to exploit prior information when it is available. In various implementations, the camera intrinsic parameters may be provided through calibration or image metadata (of the input image), and the body shape of a person might be known when imaging a known person, and distance to the camera may be estimated using a depth sensor (e.g., in the example of a camera including a depth component). At inference, these parameters may be input and used as input values in the Bayesian network to improve the determined attributes.

The attributes may also be made more accurate by determining the attributes using a set of k simultaneously taken images (from different points of view) of the same person where k is an integer greater than one. In this case, the parameter module 2908 may receive a set of parameters for each input image (from its point of view). The parameter module 2908 may decompose the pose parameters into a global rigid orientation parameter θ₀ and some intrinsic, viewpoint-independent, pose parameters

$$\tilde{{θ}_{j}} = {θ}_{0}^{- 1} {θ}_{j} ,$$

with j=1 . . . J−1. The parameter module 2908 may determine the multi-view prediction of the attributes based on maximizing the product of posterior probabilities conditioned by image features:

$${\prod }_{i = 1}^{k} {}_{1} p ( {K}_{i} , {t}_{i} , ( {θ}_{0}^{i} , {θ}_{1} … {θ}_{J - 1} ) , β , γ \vert {I}_{i} ) , \qquad ( 11 )$$

where variables specific to a view i=1 . . . k are denoted with superscript i. For greater efficiency, the parameter module 2908 may solve this problem in a greedy fashion. For example, the parameter module 2908 may start by an initial rigid alignment of predictions to estimate global orientations

$${( {θ}_{0}^{i} )}_{i = 1 … k} ,$$

and proceed into finding the optimal intrinsic orientations \tilde{θ}ⱼ that minimize the product of Fisher probability densities

$${\prod }_{i = 1}^{k} {p}_{F ( {θ}_{i 0} {F}_{ij} )} ( {\tilde{θ}}_{j} )$$

associated with each orientation j=1 . . . J−1 and each view i, see Eq. (10). A closed-form solution exists for each bone orientation \tilde{θ}ⱼ in the Procrustes orthonormalization of

$${\sum }_{i = 1}^{k} {θ}_{0}^{i} {F}_{j}^{i} .$$

With multiple input views and multiple people per view, predictions made from each view (for each human) may be matched by the parameter module 2908 to each other before they are combined. For example only, the parameter module 2908 may perform the matching using Hungarian matching or another suitable form of matching. With the Hungarian matching, the parameter module 2908 may determine the matching using cost matrices determined by the parameter module 2908 based on pairs of single-view predictions after rigid alignment.

As illustrated in FIG. 29A, a training module 2950 performs the training described herein. The training module 2950 may train parameters of the probability density module 2904 and the feature extractor module 304 based on regressing conditional distributions using an empirical cross-entropy objective function and loss [symbol] prob. [symbol] prob includes trying to maximize the log-probability density of ground truth variables

$$( {K}^{* i} , {s}^{* i} , {( {t}_{j}^{* i} , {θ}_{j}^{* i} , {β}_{j}^{* i} , {γ}_{j}^{* i} )}_{j} )$$

corresponding to images i=1 . . . n:

$${ℒ}_{prob} = \frac{- 1}{n} {\sum }_{i = 1}^{n} log p ( ( {K}^{* i} , {s}^{* i} , {( {t}_{j}^{* i} , {θ}_{j}^{* i} , {β}_{j}^{* i} , {γ}_{j}^{* i} )}_{j} ) \vert {I}_{i} ) , \qquad ( 12 )$$

this density corresponding to the product of conditional probability densities of the probability (e.g., Bayesian) network, with visible humans indexed by j. The training module 2950 may train the probability density module 2904 and the feature extractor module 304 based on minimizing objective functions by mini-batch gradient descent.

To achieve better predictions, mode extraction guiding may be performed. This may include, during training, the training module 2950 considering input camera intrinsics K and generating the attributes as discussed above for each human. This results in human mesh predictions \hat{V} including |V| vertices centered at 3D location t. Denoting TK the 2D projection operator onto the image plane, the training module 2950 may train the probability density module 2904 and the feature extractor module 304 based on minimizing an L₁ vertices reprojection error with respect to ground truth (V*,t*):

$${L}_{reproj} = \frac{1}{\vert V \vert} {\sum }_{n} \vert {π}_{K} ( {\hat{V}}_{n} + {\hat{t}}_{n} ) - {π}_{K} ( {V}_{n}^{*} + {\tilde{t}}_{n}^{*} ) \vert$$

For a predetermined percentage (e.g., 50%) of the batches during training, the training module 2950 may use random camera intrinsics of horizontal field-of-view uniformly sampled between predetermined angles, such as 5° and 170°. For the remainder of the batches, the training module 2950 may use ground-truth camera intrinsics, and train the probability density module 2904 and the feature extractor module 304 based on an additional objective function including minimizing a Li human-centered vertices loss:

$${L}_{m e s h} = \frac{1}{\vert V \vert} {\sum }_{n} {\hat{V}}_{n} - {V}_{n}^{*}$$

With these two deterministic losses included, our total objective function can thus be expressed by the equation:

$$ℒ = {ℒ}_{p r o b} + {ℒ}_{m e s h} + {ℒ}_{reproj} . \qquad ( 13 )$$

As discussed above, an input RGB image is encoded by the feature extractor module 304 (e.g., the VIT) to generate for example 1024-dimensional image patch features I, and detection features of similar dimensions. The probability density module 2904 generates the attributes for each human in the input RGB image based on the output of the feature extractor module 304.

The training module 2950 may train the probabilistic network of the probability density module 2904 and the feature extractor module 304 in an end-to-end manner to minimize the loss of equation (13). In various implementations, the training module 2950 may initialize weights of the feature extractor module 304 as described in DINOv2. In various implementations, the feature extractor module 304 may include a ViT-Large encoder with an image resolution of 518×518 and a patch size of 14×14. The probability density module 2904 may include MLPs outputting parameters of the conditional distributions taking values of conditioning variables as input and combining them through a sum in an hidden space (e.g., of dimension 256) after linear projection and rectilinear activation.

In various implementations, the training module 2950 may train using the Adam optimizer with a predetermined learning rate (e.g., 5·10⁻⁶). The training may be performed for 500k steps or another suitable number of steps and with a batch size of 16 images or another suitable batch size.

In various implementations, the training module 2950 may perform the training using only synthetic data. Synthetic data has an advantage (over real images) of mitigating personal privacy issues, it provides high accuracy ground-truth annotations, and transfers well to real word applications. In various implementations, training may be performed using the BEDLAM dataset with or without additional synthetic training data.

In various implementations, a patch with a detection likelihood score of at least 50% may be considered by the probability density module 2904 as including a human (e.g., threshold of 50%). In various implementations, a non-maximal suppression may be applied and a 3×3 patch window may be used for the detections.

As described herein, the recovery of some human attributes e.g., pose may be conditioned on other at tributes e.g., body shape. Different Bayesian (probabilistic) network connectivity may be used. For example, the connectivity illustrated in FIG. 30 may be used where an arrow from a first parameter to a second parameter indicates that the network determines the second parameter based on the first parameter. For example, in FIG. 30 pose is determined based on body shape and detection features.

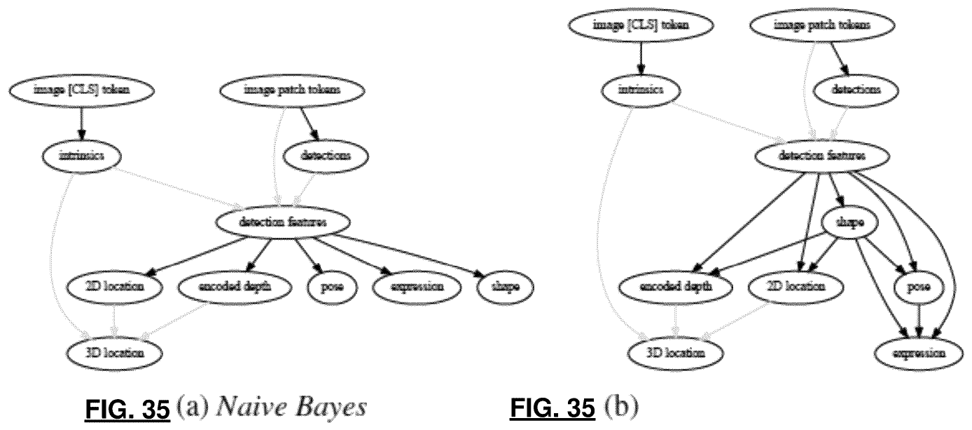

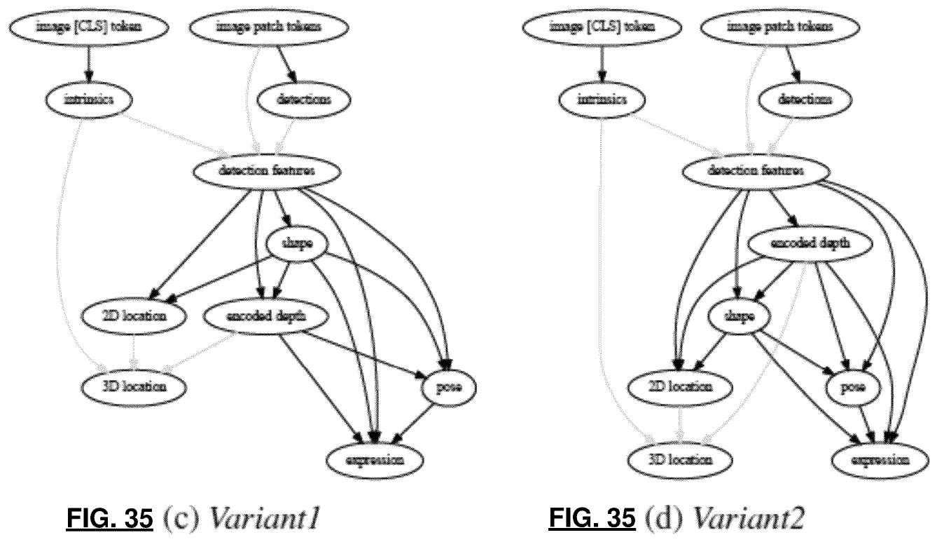

In various implementations, a Naive-Bayes that does not introduce any conditional dependency between the different person attributes could be used. An example of such a network is illustrated in FIG. 35(a). Overall, the systems and methods described herein (e.g., as illustrated in FIG. 30 and FIG. 35(b) consistently outperforms the Naive-Bayes network, especially when exploiting external knowledge about some of the variables to recover. This supports importance and benefits of modeling the inter-dependencies between human attributes as done by the systems and methods described herein.

Generally speaking, regarding FIG. 29B, for each visible person, an image feature vector I is extracted. A probability distribution over whole body poses is regressed, conditioned on the feature vector. p(β,d,θ,γ|I) denotes the corresponding probability density/distribution. Instead of determining the parameters independently, the present application involves determining a joint distribution, such as using a Bayesian network as discussed above. The network outputs a full parametric distribution over each target (β,d,θ,γ) in which relationships between targets are encoded in a cascaded manner, p(β,d,θ|I)=p(β|I)·p(d|I,β)·p(θ|I,β,d)·p(γ|I,β,d,θ).

The conditional shape distribution may be modeled as a multivariate diagonal Gaussian distribution β|I˜N(μ_{β},Σ_{β}),whose parameters are predicted by an MLP taking image features as input. The conditional expression distribution may be modeled similarly: γ|(I,β,d,θ)˜N(μ_{γ},Σ_{γ}), and its parameters μ_{γ} and Σ_{γ} may be regressed using another MLP taking image features, as well as shape, distance and pose parameters as input.

Poses may be parameterized as a tuple θ∈SO(3)_{J} of J=53 bone 3D orientations. SO(3) has a more complex topology than the PCA space of shapes and expressions, and conditional pose distribution may be modeled as a product of independent matrix Fisher distributions θ|(I,β)˜Π_{Jj=1}F(Fⱼ), of density defined up to a normalizing constant c(F) by p_{F(F)}(R)=c(F) exp(Tr(F_{τ}R)). Parameters of these distributions are similarly regressed using an MLP taking image features, and shape parameters as input.

To prevent regressing degenerate D-dimensional Gaussian distributions N(μ,σ), the mode μ∈ [symbol] ^{D} of the distribution may be regressed along with some dispersion σ∈ [symbol] ^{D} parameters, from which a diagonal covariance matrix Σ=diag(1+exp(σ))² can be defined.

The matrix parameter F∈M_{3×3}(R) of a matrix Fisher distribution F(F) may be replaced by a mode R∈SO(3) and dispersion parameters O∈SO(3), Λ∈ [symbol] ³ predicted by the MLP, and combined as follows: F=ROdiag(λ sigmoid(Λ))O^{T}. sigmoid denotes the elementwise sigmoid function and A is a strictly positive scaling constant (e.g., λ=2). Rotations may be regressed as 3×3 matrices that are orthonormalized using a differentiable special Procrustes operator.

The matrix Fisher probability density function is defined up to a normalizing constant c(F). Numerical integration may be used to evaluate it, by sampling a predetermined number (e.g., 36,864) rotations on a uniform SO(3) grid.

Next will be described how to determine whole-body mesh predictions from the probability density. The mesh parameters may be sampled according to/based on the distribution. The sampling may include sampling primitives for Gaussian distributions. In various implementations, rejection-sampling for matrix Fisher distributions may be used.

Next, the mode may be determined/extracted. In various implementations, a most likely prediction given observation (β\hat{ },d\hat{ },θ\hat{ },γ\hat{ })=argmax_{β,d,θ,γ}p(β,d,θ,γ|I) may be determined. Recovering an exact optimum may be difficult due to the non-linearities of the MLPs defining the conditional distributions. The present application may include extracting a prediction greedily by considering t conditional distributions in a feedforward manner:

$$\hat{β} = arg max p ( β \vert I ) , \hat{d} = arg max p ( d \vert I , \hat{β} ) ,$$

$$\hat{θ} = arg max p ( θ \vert I , \hat{β} , \hat{d} ) , \hat{γ} = arg max p ( γ \vert I , \hat{β} , \hat{d} , \hat{θ} ) .$$

Each of these optimization problems admit a closed-form differentiable solution and enabling to extract a mode approximation in an efficient and differentiable manner.

Using a Bayesian formalism enables injection of predetermined information (e.g., body shape and/or distance) into the mode seeking problem. When trying to recover the 3D pose of a known person of body shape (i, the predetermined information in the distance, pose and expression equations above to exploit this information. Combinations of shapes and distances to the camera may be used.

Regarding multiple views, given a set of k simultaneous observations of the same person from different viewpoints, pose parameters for the i-th observation θᵢ can be decomposed into a global rigid orientation parameter θ_{0,i} and some intrinsic, viewpoint-independent, pose parameters θ₁ . . . θ_{J}. The multi-view prediction maximizing the product of likelihoods conditioned by image features may be determined and used (Ii)i=1 . . . k:

$$arg max β , {( {d}_{i} , {θ}_{0 , i} )}_{i = 1 … k , θ 1 …θ J , γ} {\prod }_{i = 1}^{k} p ( β , {d}_{i} , ( {θ}_{0 , i} , {θ}_{1} … {θ}_{J} ) , γ \vert {I}_{i} ) .$$

The present application may proceed through iterative gradient ascent, using single-view mode predictions as initialization seeds after estimating their relative orientations with respect to a reference frame. In various implementations, the optimization may use 100 optimization steps.

The systems and methods described herein provide improved performance achieved when exploiting external inputs. Providing camera intrinsic parameters as well as distance to the camera information (interdict) provides a performance improvement in terms of mean absolute vertex position error, bringing down the average error across datasets. Exploiting external body shape information (intra-shape) similarly provides a performance boost for relative pose estimation compared to using only camera intrinsics input (intr). It also brings significant improvement in term of absolute position error, which suggests that the systems and methods herein are able to capture the relationship between visual appearance, body shape, and distance to the camera, and to exploit this dependency to produce better predictions.

The use of multiple views also results in improved performance compared to the monocular case, and providing external input leads to further performance improvements to the multi view example.

Herein describes systems and methods for multi-person human mesh recovery, based on a probabilistic Bayesian network. The use of the Bayesian network allows for incorporation of external information (camera intrinsics, body shape, distance from the camera, or even multi views)—to improve predictions. The network is able to model and exploit relationships between different attributes of the mesh recovery task (detection, camera estimation, absolute and relative pose estimation, etc.).

FIG. 31 includes example renderings generated on the left without inputting camera intrinsics and body shape and on the right with inputting camera intrinsics and body shape. Ground truths are also illustrated in grey. FIG. 31 illustrates that better mesh predictions are made by the probabilistic network with the camera intrinsics and body shape being input.

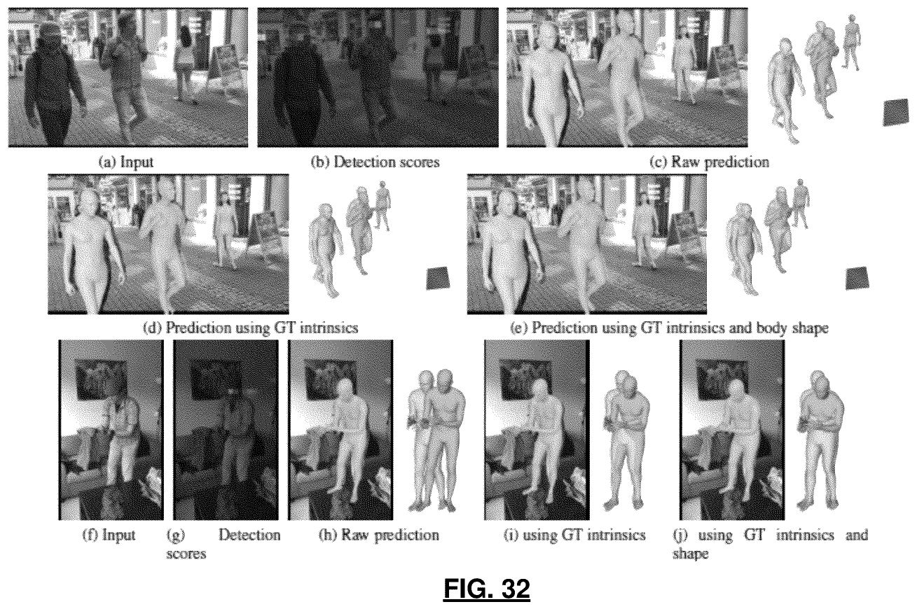

FIG. 32(a) illustrates an input RGB image. FIG. 32(b) includes detection scores generated based on the input RGB image. The rectangles in FIG. 32(b) are areas with detection scores greater than the threshold, corresponding to heads of the humans in the input RGB image.

FIG. 32(c) illustrates example meshes predicted by the probabilistic network described herein for the humans in the input RGB image without using predetermined (ground truth) camera intrinsic parameters and without body shape. FIG. 32(d) illustrates example meshes predicted by the probabilistic network described herein for the humans in the input RGB image using predetermined (ground truth) camera intrinsic parameters and without body shape. As illustrated, the predicted meshes of FIG. 32(d) are closer to the ground truth meshes (in grey) than the predicted meshes of FIG. 32(c). FIG. 32(e) illustrates example meshes predicted by the probabilistic network described herein for the humans in the input RGB image using predetermined (ground truth) camera intrinsic parameters and body shape. As illustrated, the predicted meshes of FIG. 32(e) are closer to the ground truth meshes (in grey) than the predicted meshes of FIG. 32(d) and FIG. 32(c).

FIG. 32(f) illustrates an input RGB image. FIG. 32(g) includes detection scores generated based on the input RGB image. The rectangle in FIG. 32(g) is an area with detection scores greater than the threshold, corresponding to the head of the human in the input RGB image.

FIG. 32(h) illustrates an example mesh predicted by the probabilistic network described herein for the human in the input RGB image without using predetermined (ground truth) camera intrinsic parameters and without body shape. FIG. 32(i) illustrates an example mesh predicted by the probabilistic network described herein for the human in the input RGB image using predetermined (ground truth) camera intrinsic parameters and without body shape. As illustrated, the predicted mesh of FIG. 32(i) is closer to the ground truth mesh (in grey) than the predicted mesh of FIG. 32(h). FIG. 32(j) illustrates an example mesh predicted by the probabilistic network described herein for the human in the input RGB image using predetermined (ground truth) camera intrinsic parameters and body shape. As illustrated, the predicted mesh of FIG. 32(h) is closer to the ground truth mesh (in grey) than the predicted mesh of FIG. 32(i) and FIG. 32(h).

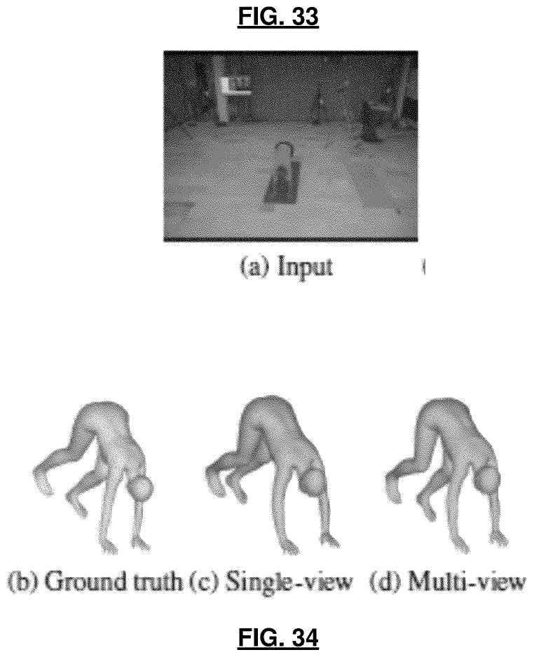

FIG. 33 (a) illustrates an input RGB image. FIG. 34 (b) includes a ground truth mesh for the human in the input RGB image. FIG. 34 (c) illustrates an example mesh predicted by the probabilistic network described herein for the human in the input RGB image based on the single input RGB image. FIG. 34 (d) illustrates an example mesh predicted by the probabilistic network described herein for the human in the input RGB image based on multiple images of the human from different points of view taken at the same time. As illustrated, the predicted mesh of FIG. 34 (d) is closer to the ground truth mesh than the predicted mesh of FIG. 34 (c), as best shown by the leg orientations.

FIGS. 35(c) and (d) illustrate examples of the probabilistic network with different independencies than FIG. 35(b). The example of FIG. 35(c) includes a denser set of conditional dependency connections than the example of FIG. 35(b). The example of FIG. 35(d) in which the dependency order between body shape and encoded depth variables is furthermore permuted. The dependency order in each example may provide different benefits. The restricted connectivity of the example of FIG. 35(b) may provide the better results than the examples of FIGS. 35(c) and 35(d).

Experiments revealed a correlation between the conditional likelihood of predictions from the probabilistic network and the prediction error. This indicates the probabilistic network described herein captures the uncertainty of its predictions to some extent, information which may be beneficial to downstream applications/tasks.

The synthetic data used for training may be generated, for example, using Blender and be generated to include different body shapes and sizes. The training data may include a set of 3D scenes, each of them including (1) a reconstructed indoor environment, (2) an environment map for background and outdoor lighting, (3) some human characters, (4) some additional indoor light sources and finally (5) some cameras for rendering. These elements may be combined so as to make scenes as realistic as possible.

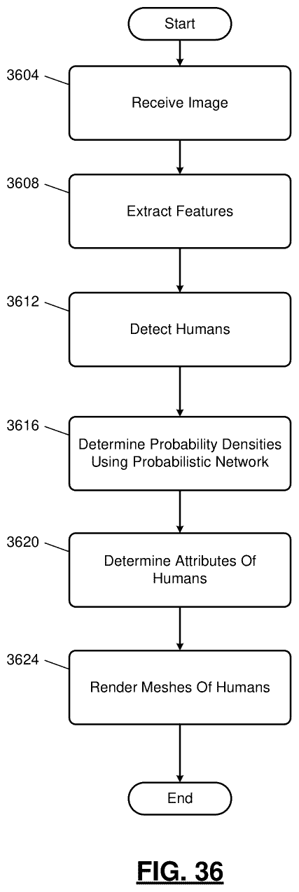

FIG. 36 is a flowchart depicting an example method of determining human meshes using the probabilistic network. Control begins with 3604 where the network receives an input image, such as a RGB (red green blue) image. At 3608, the feature extractor module 304 extracts the image features from the received image to determine the image features.

At 3612, keypoints of the humans are detected in the image based on the image features, such as using the thresholding discussed above. At 3616, the probability density module 2904 determines the sets of probability densities and selects a set of probability densities (e.g., highest probability). At 3620, the parameter module 2908 determines the parameters/attributes of the humans and other parameters based on the probability densities. The parameters/attributes may be determined further based on predetermined parameters, such as the camera intrinsics and/or body shape. At 3624, the mesh module 2912 renders the meshes of the humans in the image.

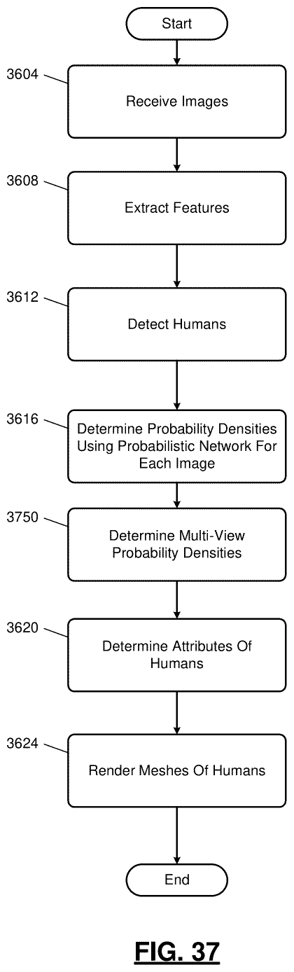

FIG. 37 is a flowchart depicting an example method of determining human meshes using multiple images taken from different points of view at approximately the same time using the probabilistic network. 3604-3616 proceed as described above. However, at 3616 each image is processed and a set of probability densities is determined for each image. At 3750, a multi-view set of probability densities is determined by the probability density module 2904 based on the sets determined for the images, respectively. For example, the probability density module 2904 may average the respective probability densities. 3620-3624 proceed as described above based on the multi-view set of probability densities.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer-implemented method for recovering a three-dimensional (3D) mesh of N humans in a 3D scene, where N is an integer greater than or equal to zero, the method comprising:
receiving a two-dimensional (2D) image of the scene captured by an image capturing device, the 2D image including a plurality of regions;
by one or more processors, encoding the received image and extracting features for each of the plurality of regions;
by one or more processors, detecting the N humans in N respective regions among the plurality of regions;
by one or more processors, based on the features in the N respective regions and the features for each of the plurality of regions, determining distribution parameters for distributions of body model and depth parameters for each of the N detected humans using a probabilistic network;
providing the distribution parameters for the body model parameters for each of the N detected humans to a 3D parametric model for generating N 3D meshes based on the distribution parameters; and
placing each of the N generated meshes at a respective 3D spatial location in the 3D scene based on the distribution parameters for the depth parameters.

2. The method of claim 1, wherein the body model parameters comprise pose and shape parameters, and the 3D mesh is a whole-body mesh.

3. The method of claim 1, wherein the probabilistic network includes a Bayesian network.

4. The method of claim 1 wherein the body model and depth parameters include location, body shape, pose, facial expression, depth, and intrinsic parameters of the image capturing device.

5. The method of claim 4 wherein the determining the distribution parameters for distributions of body model and depth parameters body model and depth parameters includes determining a distribution for the location based on the intrinsic parameters and the body shape.

6. The method of claim 4 wherein the determining the distribution parameters for distributions of body model and depth parameters body model and depth parameters includes determining a distribution for the body shape based on the features.

7. The method of claim 4 wherein the determining the distribution parameters for distributions of body model and depth parameters body model and depth parameters includes determining a distribution for the pose based on the features and the distribution for the body shape.

8. The method of claim 4 wherein the determining the distribution parameters for distributions of body model and depth parameters body model and depth parameters includes determining a distribution for the facial expression based on the features and the distributions for the pose and the body shape.

9. The method of claim 4 wherein the determining the distribution parameters for distributions of body model and depth parameters body model and depth parameters includes determining the intrinsic parameters based on a CLS token of the 2D image.

10. The method of claim 4 wherein the determining the distribution parameters for distributions of body model and depth parameters body model and depth parameters includes determining a distribution for the depth based on the features and the distribution for the body shape.

11. The method of claim 4 wherein the determining the distribution parameters for distributions of body model and depth parameters body model and depth parameters includes determining a distribution for the location based on the distribution for depth and the intrinsic parameters.

12. The method of claim 4 wherein the determining the distribution parameters for distributions of body model and depth parameters body model and depth parameters includes determining a distribution for the facial expression based on the features and the distributions for the body shape and the depth.

13. The method of claim 4 wherein the determining the distribution parameters for distributions of body model and depth parameters body model and depth parameters includes determining a distribution for the depth based on the features.

14. The method of claim 4 wherein the determining the distribution parameters for distributions of body model and depth parameters body model and depth parameters includes determining a distribution for the body shape based on the features and the distribution for the depth.

15. The method of claim 4 wherein the determining the distribution parameters for distributions of body model and depth parameters body model and depth parameters includes determining a distribution for the pose based on the features and the distributions for the depth and the body shape.

16. The method of claim 4 wherein the determining the distribution parameters for distributions of body model and depth parameters body model and depth parameters includes determining a distribution for the facial expression based on the features and the distributions for the body shape and the pose.

17. The method of claim 1, wherein determining the distribution parameters for distributions of body model and depth parameters body model and depth parameters includes determining the distribution parameters for the distributions of the body model and depth parameters further based on embedded values of ray directions of the image capture device.

18. The method of claim 1, wherein the detecting N humans comprises detecting a predetermined body keypoint in each of the N respective regions, and wherein a portion of each generated 3D mesh is centered around the predetermined body keypoint.

19. The method of claim 18, wherein the predetermined body keypoint includes one of a human head, torso, midsection, spine, or pelvis.

20. The method of claim 19, wherein said detecting a predetermined keypoint includes:
generating, for each of the plurality of regions, a probability that the predetermined body keypoint is present within the region; and
determining whether the predetermined body keypoint is present within a region based on a comparison of the generated probability for the region with a threshold.

21. The method of claim 20 wherein the determining whether the predetermined body keypoint is present within a region includes determining that the predetermined body keypoint is present within the region when the generated probability for the region is greater a threshold value.

22. The method of claim 1, wherein said encoding the received image includes encoding the received image using a Vision Transformer.

23. The method of claim 1 wherein the probabilistic network is trained using a dataset including synthetic generated images.

24. The method of claim 1, further comprising performing a downstream task using the generated 3D meshes.

25. The method of claim 24, wherein the downstream task includes at least one of:
generating a virtual 3D avatar; moving a virtual 3D avatar; actuating an autonomous device; and controlling an interaction between a between a human and an autonomous device.

26. The method of claim 24, wherein the downstream task includes controlling movement of an autonomous device to avoid objects based on the generated 3D meshes.

27. The method of claim 1 wherein the distribution parameters include probability densities.

28. The method of claim 1 wherein the determining the distribution parameters for distributions of body model and depth parameters body model and depth parameters includes determining the distribution parameters based on a predetermined body shape.

29. The method of claim 1 wherein the determining the distribution parameters for distributions of body model and depth parameters body model and depth parameters includes determining the distribution parameters based on predetermined intrinsic parameters of the image capture device.

30. The method of claim 1 wherein the determining the distribution parameters for distributions of body model and depth parameters body model and depth parameters includes determining the distribution parameters for the body model and depth parameters based on:
based on the features; and
features of M other images taken at approximately the same time as the received image from different points of view than a point of view of the received image.

31. A computer-implemented architecture for recovering a three-dimensional (3D) mesh of N humans in a 3D scene, where N is an integer greater than or equal to zero the architecture comprising:
an image encoder module configured to receive a two-dimensional (2D) image of the scene including a plurality of regions from an image capturing device and encode the received image and extract features for each of the plurality of regions;
a detector module configured to detect the N humans in N respective regions among the plurality of regions;
a decoder module configured to, based on the features in the N respective regions and the features for each of the plurality of regions, determining distribution parameters for distributions of body model and depth parameters for each of the N detected humans using a probabilistic network;
a 3D parametric model configured to receive the distribution parameters for the body model and depth parameters for each of N detected humans and generate N 3D meshes based on ones of the distribution parameters; and
a mesh positioning module configured to place each of the N generated 3D meshes at a respective 3D spatial location in the 3D scene based on ones of the distribution parameters.

32. A computer-implemented method for recovering a three-dimensional (3D) mesh of N humans in a 3D scene, where N is an integer greater than or equal to zero, the method comprising:
receiving a two-dimensional (2D) image of the scene captured by an image capturing device, the 2D image including a plurality of regions;
by one or more processors, encoding the received image and extracting features for each of the plurality of regions;
by one or more processors, detecting the N humans in N respective regions among the plurality of regions;
by one or more processors, based on the features in the N respective regions and the features for each of the plurality of regions, defining a feature vector for each of the N detected humans using a probabilistic network;
by one or more processors, determining conditional probability distribution parameters for a plurality of human attributes based on each feature vector, including shape, pose and depth, wherein determining the conditional probability distribution parameters includes determining at least one of shape, pose, and depth based on at least one other one of the shape, pose, and depth;
by one or more processors, providing the distribution parameters for the body model parameters for each of the N detected humans to a 3D parametric model for generating N 3D meshes based on the distribution parameters; and
by one or more processors, placing each of the N generated meshes at a respective 3D spatial location in the 3D scene based on the distribution parameters for the depth parameters.

33. A computer-implemented architecture for recovering a three-dimensional (3D) mesh of N humans in a 3D scene, where N is an integer greater than or equal to zero the architecture comprising:
one or more processors; and
memory including code that, when executed by the one or more processors, perform to:
receive a two-dimensional (2D) image of the scene including a plurality of regions from an image capturing device;
encode the received image and extract features for each of the plurality of regions;
detect the N humans in N respective regions among the plurality of regions;
based on the features in the N respective regions and the features for each of the plurality of regions, determine distribution parameters for distributions of body model and depth parameters for each of the N detected humans using a probabilistic network;
using a 3D parametric model, generate N 3D meshes for the N detected humans based on ones of the distribution parameters; and
place each of the N generated 3D meshes at a respective 3D spatial location in the 3D scene based on ones of the distribution parameters.
